(19) United States
(12) Patent Application Publication
(10) Pub. No.: US 2024/0402625 A1
(43) Pub. Date: Dec. 5, 2024

(54) ELECTROPHOTOGRAPHIC PHOTOSENSITIVE MEMBER, PROCESS CARTRIDGE, AND IMAGE FORMING APPARATUS

(71) Applicant: KYOCERA Document Solutions Inc., Osaka (JP)

(72) Inventors: Yuko IWASHITA, Osaka-shi (JP); Yasuhiro OISHI, Osaka-shi (JP)

(73) Assignee: KYOCERA Document Solutions Inc., Osaka (JP)

(21) Appl. No.: 18/676,137

(22) Filed: May 28, 2024

(30) Foreign Application Priority Data
May 30, 2023 (JP) 2023-088961

(51) Int. Cl. G03G 5/147; G03G 5/06; G03G 5/10; G03G 15/16; G03G 21/18

(52) U.S. Cl. CPC G03G 5/14786; G03G 5/0675; G03G 5/107; G03G 15/162; G03G 21/1814

(57) ABSTRACT

An electrophotographic photosensitive member includes a conductive substrate, an intermediate layer provided on the conductive substrate, and a photosensitive layer provided on the intermediate layer. The intermediate layer contains a specific polyamide resin and specific inorganic particles. The specific inorganic particles include metal oxide particles. The specific polyamide resin includes a first repeating unit derived from an aliphatic dicarboxylic acid and a second repeating unit derived from a diamine compound. The total percentage content of the first repeating unit and the second repeating unit is at least 80% by mol to all repeating units included in the specific polyamide resin. The photosensitive layer contains a charge generating material, an electron transport material, a binder resin, a hole transport material, and an n-type pigment.

### INCORPORATION BY REFERENCE

The present application claims priority under 35 U.S.C. § 119 to Japanese Patent Application No. 2023-088961, filed on May 30, 2023. The contents of this application are incorporated herein by reference in their entirety.

### BACKGROUND

The present disclosure relates to an electrophotographic photosensitive member, a process cartridge, and an image forming apparatus.

Electrophotographic photosensitive members are required to be able to maintain a certain level of sensitivity irrespective of the environment and form images with less fog even in high-temperature and high-humidity environments. An electrophotographic photosensitive member includes a conductive substrate, an intermediate layer provided on the conductive substrate, and a photosensitive layer provided on the intermediate layer, for example. The intermediate layer contains a binder resin and metal oxide particles, for example. The intermediate layer plays the role of increasing adhesion between the conductive substrate and the photosensitive layer and inhibiting charge injection from the side of the conductive substrate to the side of the photosensitive layer. As the electrophotographic photosensitive member including an intermediate layer, an electrophotographic photosensitive member is proposed that includes an intermediate layer with a certain physical property containing metal oxide particles.

### SUMMARY

An electrophotographic photosensitive member according to an aspect of the present disclosure includes a conductive substrate, an intermediate layer provided on the conductive substrate, and a photosensitive layer provided on the intermediate layer. The intermediate layer contains a specific polyamide resin and specific inorganic particles. The specific inorganic particles include metal oxide particles. The specific polyamide resin includes a first repeating unit derived from an aliphatic dicarboxylic acid and a second repeating unit derived from a diamine compound. A total percentage content of the first repeating unit and the second repeating unit is at least 80% by mol to all repeating units included in the specific polyamide resin. The photosensitive layer contains a charge generating material, an electron transport material, a binder resin, a hole transport material, and an n-type pigment.

A process cartridge according to an aspect of the present disclosure includes the aforementioned electrophotographic photosensitive member.

An image forming apparatus according to an aspect of the present disclosure includes an image bearing member, a charger that charges a surface of the image bearing member, a light exposure device that exposes the charged surface of the image bearing member to light to form an electrostatic latent image on the surface of the image bearing member, a development device that develops the electrostatic latent image into a toner image by supplying toner to the surface of the image bearing member, and a transfer device that transfers the toner image from the image bearing member to a transfer target. The image bearing member is the aforementioned electrophotographic photosensitive member.

### BRIEF DESCRIPTION OF THE DRAWINGS

FIG. 1 is a partial cross-sectional view of an example of an electrophotographic photosensitive member according to a first embodiment of the present disclosure.

FIG. 2 is a diagram illustrating an example of an image forming apparatus according to a second embodiment of the present disclosure.

FIG. 3 is a diagram illustrating an example of the configuration of a development device illustrated in FIG. 2.

### DETAILED DESCRIPTION

The following describes embodiments of the present disclosure in detail. However, the present disclosure is not limited to the following embodiments and can be practiced with appropriate alteration added within the scope of the purpose of the present disclosure.

The term “(meth)acryl” may be used as a generic term for both acryl and methacryl. The term “(meth)acrylate” is used as a generic term for both acrylate and methacrylate. Unless otherwise stated, the number average particle diameter of a powder is a number average value of equivalent circle diameters (Heywood diameters: diameters of circles having the same areas as projected areas of the primary particles) of primary particles of the powder as measured using a scanning electron microscope. The number average primary particle diameter of a powder is a number average value of equivalent circle diameters of 100 primary particles of the powder, for example. In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. The term “formula” is used collectively for both “general formulas” and “chemical formulas”. >The phrase “each represent, independently of one another,” in description about formulas means possibly representing the same group or different groups. Unless otherwise stated, one type of each component described in the present specification may be used independently, or two or more types of the component may be used in combination. For example, the phrases “at least one of A, B, and C” and “any of A, B, and C” are the same as the phrase “at least one selected from the group consisting of A, B, and C”.

### First Embodiment: Electrophotographic Photosensitive Member

A first embodiment of the present disclosure relates to an electrophotographic photosensitive member (also referred to below as a photosensitive member). The photosensitive member of the present embodiment includes a conductive substrate, an intermediate layer provided on the conductive substrate, and a photosensitive layer provided on the intermediate layer. The intermediate layer contains a specific polyamide resin and specific inorganic particles. The specific inorganic particles include metal oxide particles. The specific polyamide resin includes a first repeating unit derived from an aliphatic dicarboxylic acid and a second repeating unit derived from a diamine compound. The total percentage content of the first repeating unit and the second repeating unit is at least 80% by mol to all repeating units included in the specific polyamide resin. The photosensitive layer contains a charge generating material, an electron transport material, a binder resin, a hole transport material, and an n-type pigment.

As a result of having the above features, the photosensitive member of the present embodiment can have reduced environmental dependence of sensitivity and inhibit occurrence of fogging in high-temperature and high-humidity environments. The reasons therefor are inferred as follows. The photosensitive member of the present embodiment contains an n-type pigment in the photosensitive layer. The n-type pigment exhibits a function of increasing dispersibility of the charge generating material in the binder resin in the photosensitive layer. As a result, the n-type pigment optimizes sensitivity (particularly, sensitivity in low-temperature and low-humidity environments) of the photosensitive member of the present embodiment. The intermediate layer of the photosensitive member of the present embodiment exhibits a function of not inhibiting flow of electric current generated during light exposure of the photosensitive member to light while exhibiting voltage resistance to the extent that current leakage does not occur. Thus, provision of the intermediate layer can stabilize sensitivity (especially, sensitivity in low-temperature and low-humidity environments) of the photosensitive member of the present embodiment. In particular, the photosensitive member of the present embodiment can inhibit sufficient sensitivity even in low-temperature and low-humidity environments as a result of synergetic effect of the function of the intermediate layer and the function of the n-type pigment contained in the photosensitive layer. Therefore, the photosensitive member of the present embodiment can inhibit a phenomenon of increasing and decreasing sensitivity depending on the environment. Intermediate layers of known photosensitive members decrease in resistance due to moisture absorption in high-temperature and high-humidity environments, tending to cause current leakage. As a result, the intermediate layers of known photosensitive members may not sufficiently exhibit their function in high-temperature and high-humidity environments. By contrast, the intermediate layer of the photosensitive member of the present embodiment contains the specific polyamide resin and the specific inorganic particles. The specific polyamide resin and the specific inorganic particles inhibit moisture absorption of the intermediate layer in high-temperature and high-humidity environments and tend to allow the intermediate layer to exhibit the aforementioned function. The polyamide resin can be produced only with diamine and dicarboxylic acid as a typical feature thereof, enabling achievement of a stable product. Therefore, the photosensitive member of the present embodiment can inhibit occurrence of fogging in high-temperature and high-humidity environments. The photosensitive member is further described below.

The photosensitive member of the present embodiment is a single-layer electrophotographic photosensitive member (also referred to below as a single-layer photosensitive member), for example. The single-layer photosensitive member is a positively chargeable single-layer photosensitive member, for example.

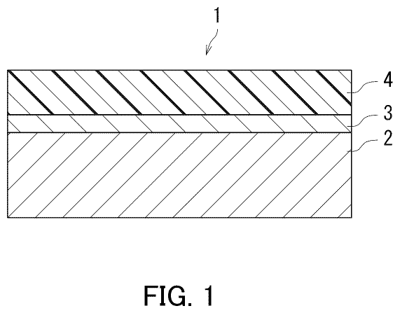

The structure of a photosensitive member 1, which is an example of the photosensitive member of the present embodiment, is described below with reference to FIG. 1. FIG. 1 is a partial cross-sectional view of the photosensitive member 1. As illustrated in FIG. 1, the photosensitive member 1 includes a conductive substrate 2, an intermediate layer 3 provided on the conductive substrate 2, and a photosensitive layer 4 provided on the intermediate layer 3, for example. The photosensitive layer 4 is a photosensitive layer of a single layer (also referred to below as a single-layer photosensitive layer).

The intermediate layer 3 has a thickness of preferably at least 1 μm and no greater than 20 μm, and more preferably at least 1 μm and no greater than 10 km.

The thickness of the photosensitive layer 4 is not limited particularly and is preferably at least 5 μm and no greater than 100 μm, and more preferably at least 10 μm and no greater than 50 μm. The structure of the photosensitive member 1 being an example of the photosensitive member of the present embodiment has been described so far with reference to FIG. 1.

However, the structure of the photosensitive member of the present embodiment may differ from that illustrated in FIG. 1. For example, the photosensitive member of the present embodiment may further include another layer (e.g., a protective layer provided on the photosensitive layer) in addition to the conductive substrate, the intermediate layer, and the photosensitive layer.

### [Intermediate Layer]

The intermediate layer contains a specific polyamide resin and specific organic particles. Presence of the intermediate layer can allow smooth flow of electric current generated during light exposure of the photosensitive member while maintaining the insulation state to the extent that occurrence of current leakage can be inhibited, thereby inhibiting an increase in resistance. Preferably, the intermediate layer contains only the specific polyamide resin and the specific organic particles. Specifically, the total percentage content of the specific polyamide resin and the specific organic particles is preferably at least 90% by mass in the intermediate layer, more preferably at least 99% by mass, and further preferably 100% by mass.

### (Specific Polyamide Resin)

The specific polyamide resin includes a first repeating unit derived from an aliphatic dicarboxylic acid and a second repeating unit derived from a diamine compound. The total percentage content of the first repeating unit and the second repeating unit is at least 80% by mol to all repeating units included in the specific polyamide resin, more preferably at least 95% by mol, and further preferably 100% by mol.

The specific polyamide resin may include one or more first repeating units and one or more second repeating units. Preferably, the specific polyamide resin includes one first repeating unit and one second repeating unit.

The aliphatic dicarboxylic acid is represented by formula “COOH—(CH₂)n-COOH”, for example. The integer represented by n is preferably at least 8 and no greater than 20, and more preferably at least 8 and no greater than 12. In other words, the carbon number of the aliphatic dicarboxylic acid is preferably at least 8 and no greater than 20, and more preferably at least 8 and no greater than 12. Examples of the aliphatic dicarboxylic acid with a carbon number of at least 8 and no greater than 20 include octanedioic acid, nonanedioic acid, decanedioic acid, undecanedioic acid, dodecanedioic acid, tridecanedioic acid, tetradecanedioic acid, pentadecanedioic acid, hexadecanedioic acid, heptadecanedioic acid, octadecanedioic acid, nonadecanedioic acid, and eicosanedioic acid. Preferably, the aliphatic dicarboxylic acid is octanedioic acid, decanedioic acid, or dodecanedioic acid.

Examples of the diamine compound include aliphatic diamine compounds (e.g., aliphatic diamine compounds with a carbon number of at least 4 and no greater than 14) and diamine compounds having a cycloalkane structure. Preferably, the diamine compound is a diamine compound having a cycloalkane structure.

Examples of the cycloalkane structure of the diamine compound having a cycloalkane structure include a cyclopentane structure, a cyclohexane structure, a cycloheptane structure, a cyclooctane structure, a bicyclopentane structure, and a decalin structure. Examples of the diamine compound having a cycloalkane structure include 1,2-cyclopentanediamine, 1,3-cyclopentanediamine, 1,2-cyclohexanediamine, 1,3-cyclohexanediamine, 1,4-cyclohexanediamine, isophoronediamine, 4,4-methylenebis-2-methylcyclohexylamine, 2,5-bis(aminomethyl)bicyclo[2,2,1]heptane, and 2,6 (aminomethyl)bicyclo[2,2,1]heptane. The diamine compound having a cycloalkane structure is preferably isophoronediamine or 4,4-methylenebis-2-methylcyclohexylamine, and more preferably isophoronediamine.

The specific polyamide resin may include an additional repeating unit (e.g., a repeating unit derived from a lactam compound) in addition to the first repeating unit and the second repeating unit, as long as the amount thereof is small. However, it is preferable that the specific polyamide resin does not include a repeating unit derived from an aromatic dicarboxylic acid. Specifically, the repeating unit derived from an aromatic dicarboxylic acid has a percentage content of preferably no greater than 5% by mol to all repeating units included in the specific polyamide resin, more preferably no greater than 1% by mol, and further preferably 0% by mol.

Preferably, the specific polyamide resin is any of polymers of the following monomer mixtures (a1) to (a4). In the following, the polymers of the monomer mixtures (a1) to (a4) may be also referred to below as polyamide resins (a1) to (a4), respectively.
a1: mixture of dodecanedioic acid and isophoronediamine
a2: mixture of decanedioic acid and isophoronediamine
a3: mixture of octanedioic acid and isophoronediamine
a4: mixture of dodecanedioic acid and 4,4-methylenebis-2-methylcyclohexylamine

The specific polyamide resin has a percentage content of preferably at least 8% by mass and no greater than 70% by mass in the intermediate layer, and more preferably at least 12% by mass and no greater than 65% by mass. As a result of the percentage content of the specific polyamide resin being set to at least 8% by mass and no greater than 70% by mass, the specific polyamide resin can easily exhibit a function as the binder resin of the intermediate layer.

### (Specific Inorganic Particles)

The specific inorganic particles include metal oxide particles. Preferably, the specific inorganic particles include surface treatment layers covering at least parts of the surfaces of the respective metal oxide particles. As a result of including the surface treatment layers, the specific inorganic particles tend to be highly dispersed in the intermediate layer. The specific inorganic particles have a number average primary particle diameter of preferably at least 5 nm and no greater than 100 nm, more preferably at least 5 nm and no greater than 50 nm, and further preferably at least 5 nm and no greater than 20 nm.

The specific inorganic particles have a content of at least 50 parts by mass and no greater than 1000 parts by mass relative to 100 parts by mass of the specific polyamide resin in the intermediate layer, more preferably at least 100 parts by mass and no greater than 600 parts by mass, and further preferably at least 150 parts by mass and no greater than 500 parts by mass. As a result of the content of the specific inorganic particles being set to at least 50 parts by mass and no greater than 1000 parts by mass, the intermediate layer can further effectively play the roles of increasing adhesion between the conductive substrate and the photosensitive layer and inhibiting charge injection from the conductive substrate side to the photosensitive layer side.

### (Metal Oxide Particles)

Examples of the metal oxide particles include alumina particles, zinc oxide particles, titanium oxide particles, and particles of conductive metal oxides (e.g., phosphorous-doped tin oxide and antimony-doped tin oxide). The metal oxide particles are preferably titanium oxide particles or zinc oxide particles, and more preferably titanium oxide particles.

Note that the surface treatment layers of the specific inorganic particles are very thin. Therefore, the number average primary particle diameter of the metal oxide particles is approximately the same as the number average primary particle diameter of the specific inorganic particles.

The metal oxide particles have a percentage content of preferably at least 80% by mass and no greater than 99% by mass in the specific inorganic particles, and more preferably at least 85% by mass and no greater than 93% by mass.

### (Surface Treatment Layers)

As stated above, it is preferable that the specific inorganic particles include surface treatment layers covering at least parts of the metal oxide particles. In this case, the surface treatment layers preferably contain at least one of aluminum oxide, silica, zirconia, stearic acid, and a component derived from an organic siloxane compound. Note that aluminum oxide, silica, and the zirconia form fine particles or homogenous film on the surface treatment layers, for example. The component derived from an organic siloxane compound may be an organic siloxane compound itself or a compound generated by chemical reaction of an organic siloxane compound with the metal oxide particles, oxygen or the like. The surface treatment layers may have a single-layer structure or a multilayer structure.

The organic siloxane compound is a compound with a siloxane bond (Si—O—Si bond) having an organic group (e.g., an alkyl group with a carbon number of at least 1 and no greater than 5 optionally substituted with a substituent, a cycloalkyl group with a carbon number of at least 4 and no greater than 8 optionally substituted with a substituent, or an aryl group with a carbon number of at least 6 and no greater than 10 optionally substituted with a substituent). Preferably, the organic group is a methyl group, an ethyl group, or a phenyl group. Note that the organic siloxane compound may be a commercially available product named “silicone oil”.

The organic siloxane compound is a polysiloxane compound substituted with an organic group, for example. Example of the polysiloxane compound substituted with an organic group include dimethylpolysiloxane, methylphenylpolysiloxane, and methylhydrogenpolysiloxane. Preferably, the organic siloxane compound is methylhydrogenpolysiloxane.

The total percentage content of any of aluminum oxide, silica, zirconia, stearic acid, and the compound derived from an organic siloxane compound is preferably at least 90% by mass in the surface treatment layers, more preferably at least 99% by mass, and further preferably 100% by mass. Preferably, the surface treatment layers contain only aluminum oxide and silica, contain only aluminum oxide, contain only aluminum oxide and zirconia, contain only silicone oil, contain only aluminum oxide, silica, and methylpolysiloxane, or contain only aluminum oxide and stearic acid.

The surface treatment layers are layers formed by surface treatment of the metal oxide particles with a surface treatment agent. Example of the surface treatment agent include organic siloxane compounds, aluminum oxide, silica, zirconia, and stearic acid. The surface treatment agent may contain a compound (e.g., aluminum hydroxide, water-containing silica hydroxide, or zirconium hydroxide) that generates aluminum oxide, silica, or zirconia by treatment such as baking. An example of the surface treatment is application of a surface treatment agent to the metal oxide particles followed by baking.

The surface treatment layers have a content of preferably at least 1 part by mass and no greater than 30 parts by mass relative to 100 parts by mass of the metal oxide particles, and more preferably at least 5 parts by mass and no greater than 20 parts by mass. As a result of the content of the surface treatment layers being set to at least 1 part by mass, dispersibility of the specific inorganic particles in the intermediate layer can be further optimized. As a result of the content of the surface treatment layers being set to no greater than 30 parts by mass, the specific inorganic particles can have optimized resistance.

The specific inorganic particles are preferably any of specific inorganic particles (t1) to (t7) that have the respective constitutions indicated in Table 1. Note that the column titled “Surface treatment layers” in Table 1 indicates the component(s) contained in the corresponding surface treatment layers. For example, “Silica+Alumina” in the column titled “Surface treatment layers” for the specific inorganic particles (t1) means that the surface treatment layers contain silica and alumina. “MHPS” refers to methylhydrogenpolysiloxane. The column titled “Number average primary particle diameter” indicates a preferable numerical range of the number average primary particle diameter of the corresponding specific inorganic particles. For example, “7-15” in the column titled “Number average primary particle diameter” for the specific inorganic particles (t1) means that the number average primary particle diameter of the specific inorganic particles (t1) is at least 7 nm and no greater than 15 nm.

TABLE 1

| | | | Number average |
|---|---|---|---|
| | | Surface treatment | primary particle |
| | Metal oxide particles | layers | diameter [nm] |
| t1 | Titanium oxide particles | Silica + Alumina | 7-15 |
| t2 | Titanium oxide particles | Alumina | 35-45 |
| t3 | Titanium oxide particles | Alumina + Zirconia | 25-35 |
| t4 | Zinc oxide particles | Silicone oil | 30-40 |
| t5 | Titanium oxide particles | Silicone oil | 75-85 |
| t6 | Titanium oxide particles | Alumina + Silica + | 30-40 |
| | | MHPS | |
| t7 | Titanium oxide particles | Alumina + Stearic acid | 10-20 |

### [Photosensitive Layer]

The photosensitive layer contains a charge generating material, an electron transport material, a binder resin, a hole transport material, and an n-type pigment. The photosensitive layer may further contain an additive as necessary.

### (Charge Generating Material)

Examples of the charge generating material include phthalocyanine-based pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (e.g., selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, and pyrazoline-based pigments.

The phthalocyanine-based pigments have a phthalocyanine structure. Examples of the phthalocyanine-based pigments include metal phthalocyanines and metal-free phthalocyanine. Examples of the metal phthalocyanines include titanyl phthalocyanine, hydroxygallium phthalocyanine, and chlorogallium phthalocyanine. A preferable metal phthalocyanine is titanyl phthalocyanine. Titanyl phthalocyanine is represented by formula (CG-1). Metal-free phthalocyanine is represented by formula (CG-2).

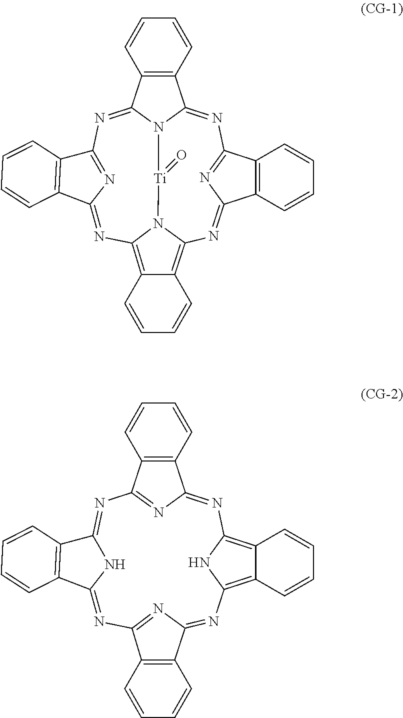

The phthalocyanine-based pigments may be crystalline or non-crystalline. An example of crystalline metal-free phthalocyanine is metal-free phthalocyanine having an X-form crystal structure (also referred to below as X-form metal-free phthalocyanine). Examples of crystalline titanyl phthalocyanine include titanyl phthalocyanine having an α-form crystal structure, titanyl phthalocyanine having a β-form crystal structure, and titanyl phthalocyanine having a Y-form crystal structure (also referred to below as α-form titanyl phthalocyanine, β-form titanyl phthalocyanine, and Y-form titanyl phthalocyanine, respectively).

For example, a photosensitive member having a sensitivity to light in a wavelength range of at least 700 nm is preferably used in digital optical image forming apparatuses (e.g., laser beam printers or facsimiles using a light source such as semiconductor laser). The charge generating material is preferably a phthalocyanine-based pigment because it exhibits a high quantum yield in a wavelength range of at least 700 nm. More preferable one is titanyl phthalocyanine, and further preferable one is Y-form titanyl phthalocyanine.

Y-form titanyl phthalocyanine exhibits a main peak for example at a Bragg angle (2θ±0.2°) of 27.2° in a CuKα characteristic X-ray diffraction spectrum. The term main peak refers to a peak that is the most intense or second most intense peak within a range of Bragg angles (2θ±0.2°) between 3° and 40° in a CuKα characteristic X-ray diffraction spectrum. Y-form titanyl phthalocyanine does not exhibit a peak at 26.2° in the CuKα characteristic X-ray diffraction spectrum.

The CuKα characteristic X-ray diffraction spectrum can be plotted by the following method, for example. First, a sample (titanyl phthalocyanine) is loaded into a sample holder of an X-ray diffractometer (e.g., “RINT (registered Japanese trademark) 1100”, product of Rigaku Corporation). Then, an X-ray diffraction spectrum is plotted under conditions of use of an X-ray tube made from Cu, a tube voltage of 40 kV, a tube current of 30 mA, and a wavelength of the CuKα characteristic X-ray of 1.542 Å. The measurement range (2θ) is for example from 3° to 40° (start angle: 3°, stop angle: 40°), and the scanning speed is for example 10°/min. The main peak is identified from the plotted X-ray diffraction spectrum and the Bragg angle of the main peak is read.

The charge generating material has a content of at least 0.1 parts by mass and no greater than 10.0 parts by mass relative to 100 parts by mass of the binder resin in the photosensitive layer, and more preferably at least 2.0 parts by mass and no greater than 6.0 parts by mass.

### (Hole Transport Material)

Examples of the hole transport material include triphenylamine derivatives, diamine derivatives (e.g., an N,N,N′,N′-tetraphenylbenzidine derivative, an N,N,N′,N′-tetraphenylphenylenediamine derivative, an N,N,N′,N′-tetraphenylnaphtylenediamine derivative, an N,N,N′,N′-tetraphenylphenanthrylenediamine derivative, and an di(aminophenylethenyl)benzene derivative), oxadiazole-based compounds (e.g., 2,5-di(4-methylaminophenyl)-1,3,4-oxadiazole), styryl-based compounds (e.g., 9-(4-diethylaminostyryl)anthracene), carbazole-based compounds (e.g., polyvinyl carbazole), organic polysilane compounds, pyrazoline-based compounds (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compound.

Examples of the hole transport material include compounds represented by formulas (10), (20), (21), (23), (24), and (25) (also referred to below as hole transport materials (10), (20), (21), (23), (24), and (25), respectively).

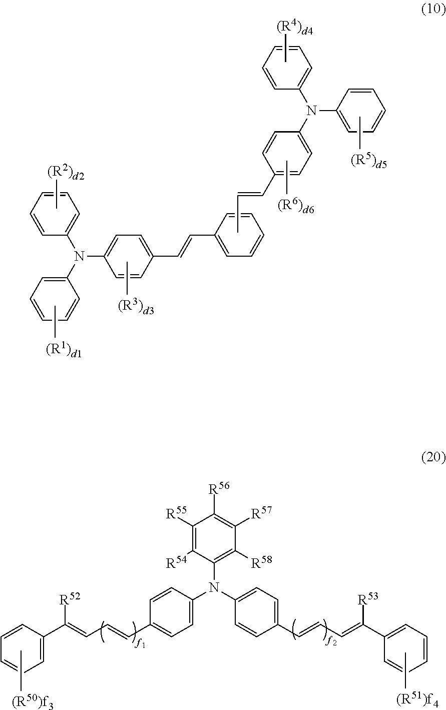

In formula (10), R¹ to R⁶ each represent, independently of one another, a phenyl group, an alkyl group with a carbon number of at least 1 and no greater than 8, or an alkoxy group with a carbon number of at least 1 and no greater than 8. d1, d2, d4, and d5 each represent, independently of one another, an integer of at least 0 and no greater than 5. d3 and d6 each represent, independently of one another, an integer of at least 0 and no greater than 4. Preferably, R¹ to R⁶ each represent, independently of one another, an alkyl group with a carbon number of at least 1 and no greater than 3. Preferably, d1, d2, d4, and d5 each represent, independently of one another, 0, 1, or 2. Preferably, d3 and d6 each represent 0.

When d1 to d6 in formula (10) each represent an integer of at least 2, the multiple chemical groups R¹ to the multiple chemical groups R⁶ may represent the same group as or different groups from each other.

In formula (20), R⁵⁰ and R⁵¹ each represent, independently of one another, a phenyl group, an alkyl group with a carbon number of at least 1 and no greater than 6, or an alkoxy group with a carbon number of at least 1 and no greater than 6. R⁵², R⁵³, R⁵⁴, R⁵⁵, R⁵⁶, R⁵⁷, and R⁵¹ each represent, independently of one another, a hydrogen atom, an alkyl group with a carbon number of at least 1 and no greater than 6, an alkoxy group with a carbon number of at least 1 and no greater than 6, or a phenyl group optionally substituted with an alkyl group with a carbon number of at least 1 and no greater than 6. f₁ and f₂ each represent, independently of one another, an integer of at least 0 and no greater than 2. f₃ and f₄ each represent, independently of one another, an integer of at least 0 and no greater than 5.

In formula (20), when f₃ represents an integer of at least 2 and no greater than 5, the multiple chemical groups R⁵⁰ may represent the same group as or different groups from each other. When f₄ represents an integer of at least 2 and no greater than 5, the multiple chemical groups R⁵¹ may represent the same group as or different groups from each other.

In formula (20), preferably, R⁵⁰ and R⁵¹ each represent, independently of one another, an alkyl group with a carbon number of at least 1 and no greater than 3. Preferably, R⁵² and R⁵³ each represent a hydrogen atom or a phenyl group optionally substituted with a methyl group. Preferably, R⁵⁴ to R⁵⁸ each represent, independently of one another, a hydrogen atom, an alkyl group with a carbon number of at least 1 and no greater than 4, or an alkoxy group with a carbon number of at least 1 and no greater than 3. Preferably, f₁ and f₂ each represent 0 or each represent 1. Preferably, f₃ and f₄ each represent, independently of one another, 0 or 1.

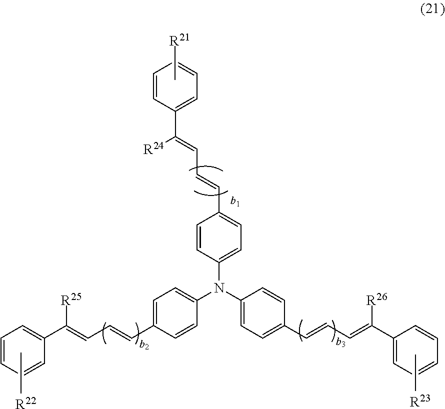

In formula (21), R²¹, R²², and R²³ each represent, independently of one another, an alkyl group with a carbon number of at least 1 and no greater than 6. R²⁴, R²⁵, and R²⁶ each represent, independently of one another, a hydrogen atom or an alkyl group with a carbon number of at least 1 and no greater than 6. b₁, b₂, and b₃ each represent, independently of one another, 0 or 1.

In formula (21), preferably, R²¹, R²², and R²³ each represent, independently of one another, an alkyl group with a carbon number of at least 1 and no greater than 3, and more preferably represent a methyl group. R²¹, R²², and R²³ are preferably bonded to a phenyl group at the meta-position thereof relative to an ethenyl or a butadienyl group. Preferably, R²⁴, R²⁵, and R²⁶ each represent a hydrogen atom. Preferably, b₁, b₂, and b₃ each represent 0 or each represent 1.

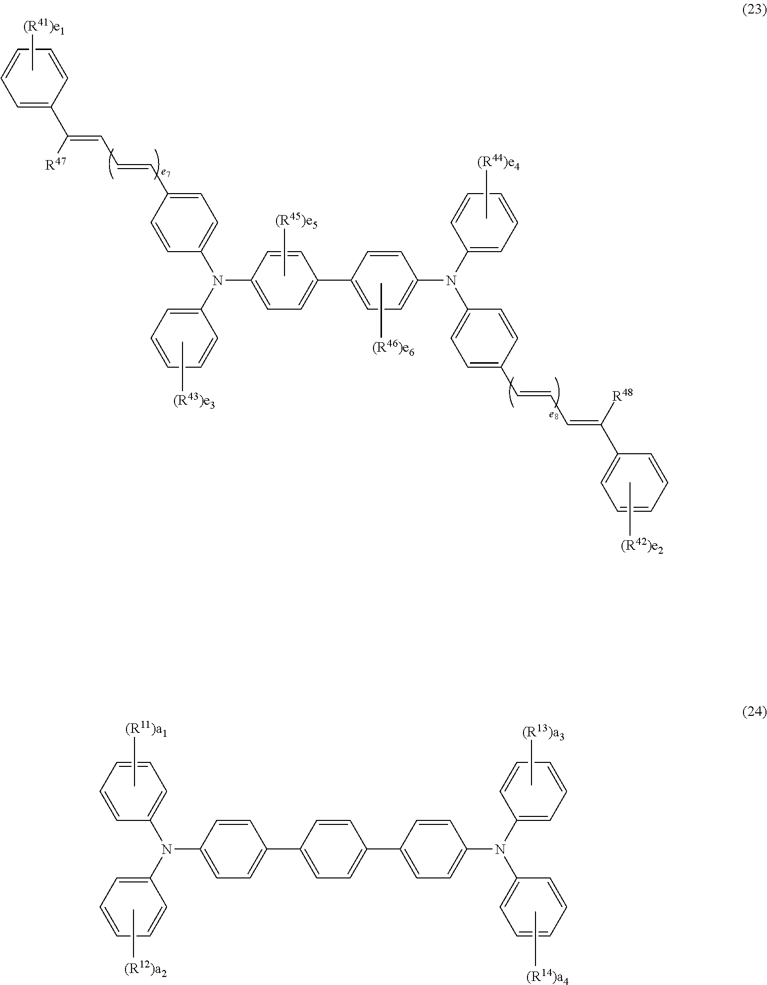

In formula (23), R⁴¹, R⁴², R⁴³, R⁴⁴, R⁴⁵, and R⁴⁶ each represent, independently of one another, a phenyl group or an alkyl group with a carbon number of at least 1 and no greater than 6. R⁴⁷ and R⁴⁸ each represent, independently of one another, a hydrogen atom, a phenyl group, or an alkyl group with a carbon number of at least 1 and no greater than 6. e₁, e₂, e₃, and e₄ each represent, independently of one another, an integer of at least 0 and no greater than 5. e₅ and e₆ each represent, independently of one another, an integer of at least 0 and no greater than 4. e₇ and e₈ each represent, independently of one another, 0 or 1.

In formula (23), when e₁ to e₆ each represent an integer of at least 2 and no greater than 4, the multiple chemical groups R⁴¹ to the multiple chemical groups R⁴⁶ may represent the same group as or different groups from each other.

In formula (23), preferably, R⁴¹ to R⁴⁶ each represent, independently of one another, an alkyl group with a carbon number of at least 1 and no greater than 3. Preferably, R⁴⁷ and R⁴⁸ each represent a hydrogen atom. Preferably, e₁, e₂, e₅, and e₆ each represent 0. Preferably, e₃ and e₄ each represent 2. Preferably, e₇ and e₈ each represent 0 or each represent 1.

In formula (24), R¹¹, R¹², R¹³, and R¹⁴ each represent, independently of one another, an alkyl group with a carbon number of at least 1 and no greater than 6 or an alkoxy group with a carbon number of at least 1 and no greater than 6. a₁, a₂, a₃, and a₄ each represent, independently of one another, an integer of at least 0 and no greater than 5.

In formula (24), when a₁ to a₄ each represent an integer of at least 2 and no greater than 5, the multiple chemical groups R¹¹ to the multiple chemical groups R¹⁴ may represent the same group as or different groups from each other.

In formula (24), preferably, R¹¹, R¹², R¹³, and R¹⁴ each represent, independently of one another, an alkyl group with a carbon number of at least 1 and no greater than 3. Preferably, a₁, a₂, a₃, and a₄ each represent, independently of one another, 0 or 1.

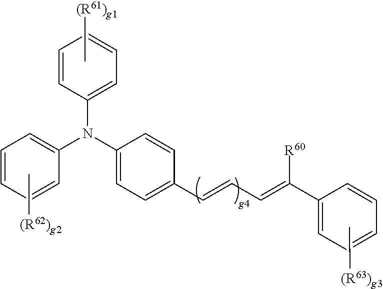

In formula (25), R⁶⁰ represents a hydrogen atom, an alkyl group with a carbon number of at least 1 and no greater than 8, an alkoxy group with a carbon number of at least 1 and no greater than 8, or a phenyl group optionally substituted with an alkyl group with a carbon number of at least 1 and no greater than 8. R⁶¹, R⁶², and R⁶³ each represent, independently of one another, an alkyl group with a carbon number of at least 1 and no greater than 8 or an alkoxy group with a carbon number of at least 1 and no greater than 8. g1, g2, and g3 each represent, independently of one another, an integer of at least 0 and no greater than 5. g4 represents 0 or 1. Preferably, R⁶⁰ represents a phenyl group. Preferably, R⁶¹, R⁶², and R⁶³ each represent, independently of one another, an alkyl group with a carbon number of at least 1 and no greater than 3. Preferably, g1 and g2 each represent 1. Preferably, g3 represents 0.

In formula (25), when g1 to g3 each represent an integer of at least 2 and no greater than 5, the multiple chemical groups R⁶¹ to the multiple chemical groups R⁶³ may represent the same group as or different groups from each other.

The hole transport material preferably includes at least one of compounds represented by formulas (HTM-1) to (HTM-12) (also referred to below as hole transport materials (HTM-1) to (HTM-12), respectively).

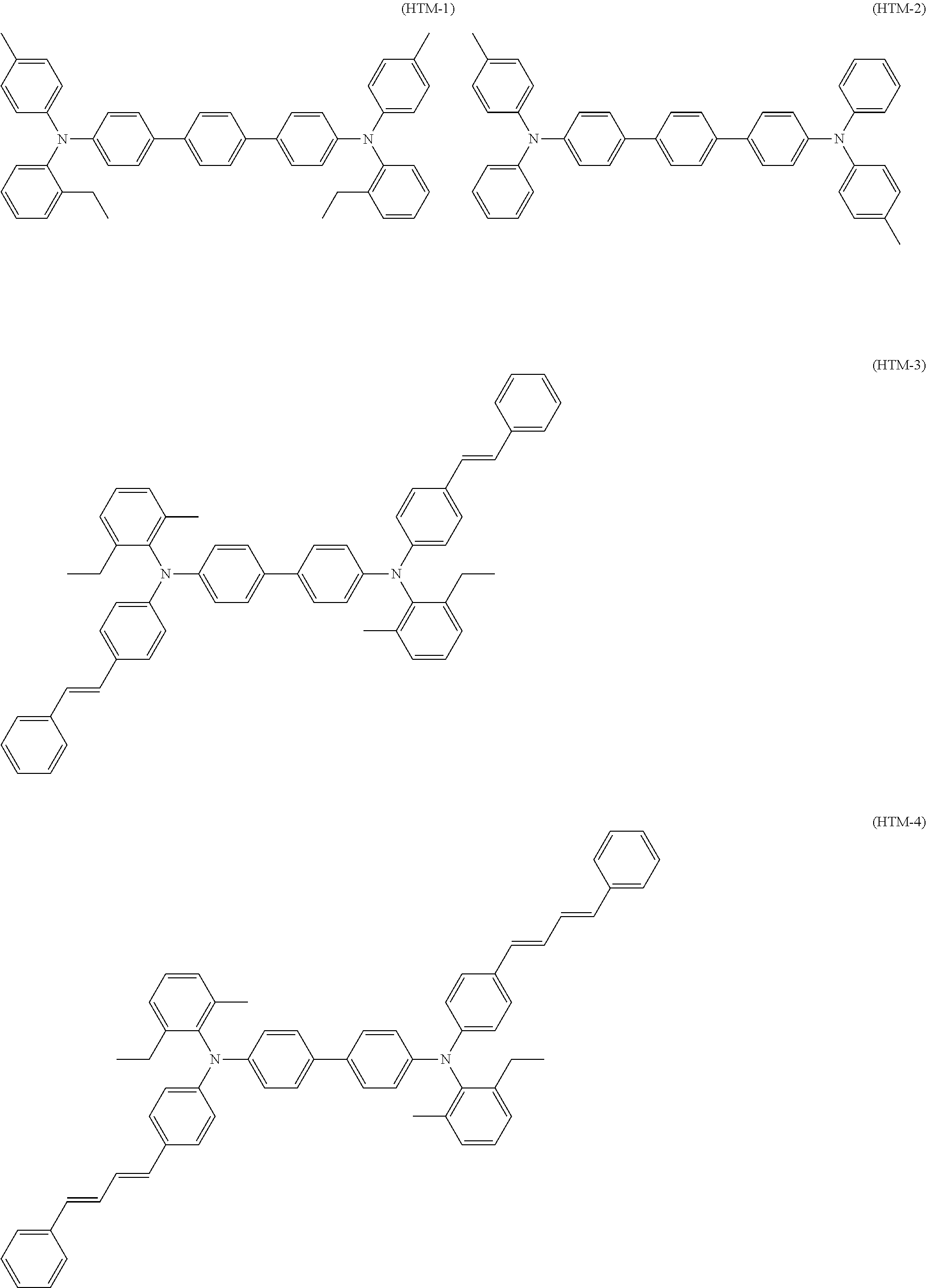

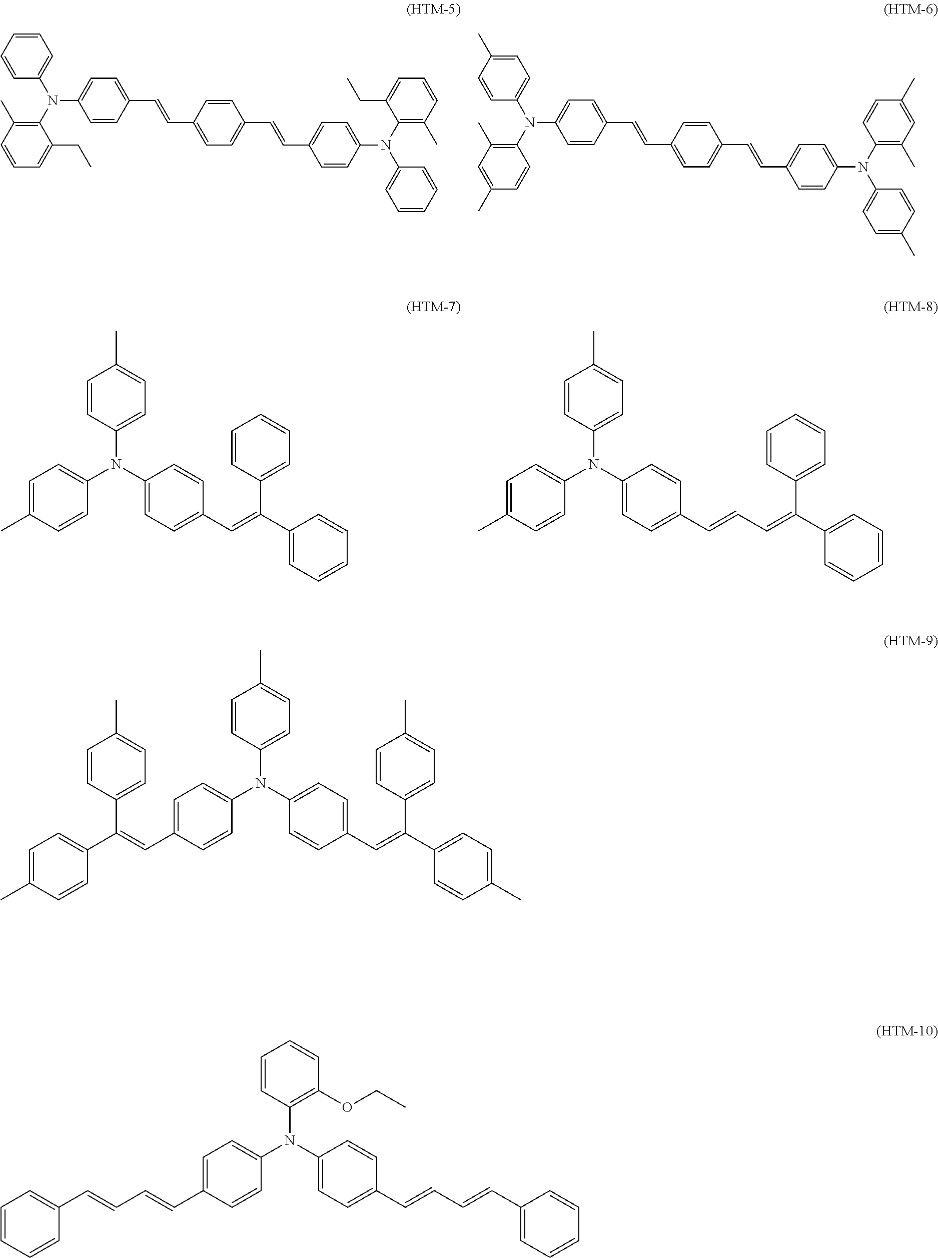

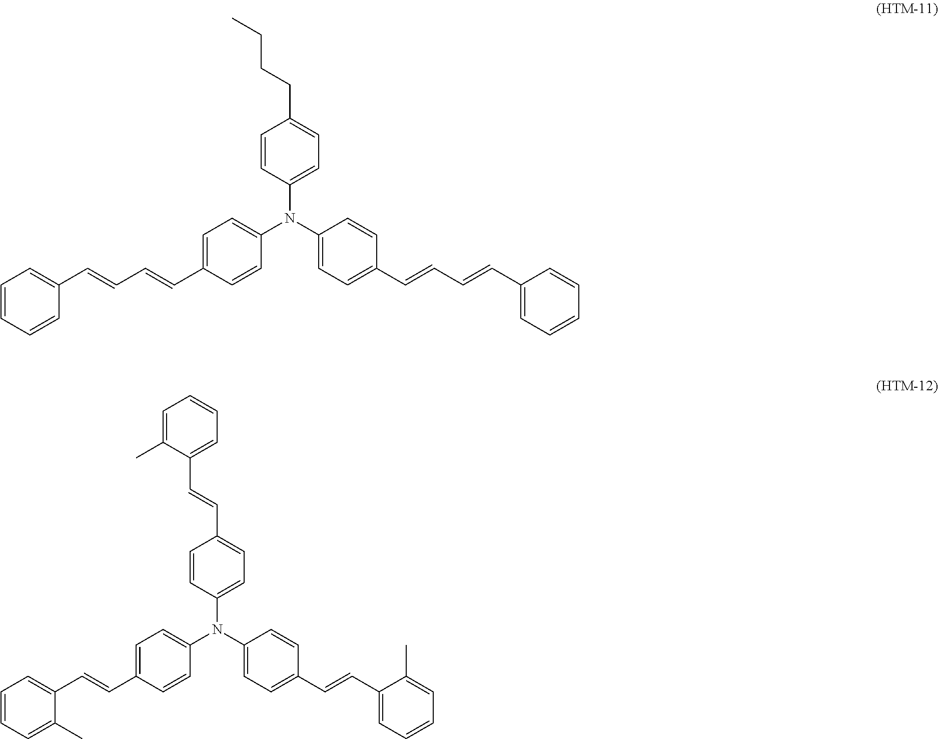 [SMILES: CCCCc1ccc(N(c2ccc(/C=C/C=C/c3ccccc3)cc2)c2ccc(/C=C/C=C/c3ccccc3)cc2)cc1 ; Cc1ccccc1/C=C/c1ccc(N(c2ccc(/C=C/c3ccccc3C)cc2)c2ccc(/C=C/c3ccccc3C)cc2)cc1]

The total percentage content of any of the hole transport materials (10), (20), (21), (23), (24), and (25) is preferably at least 80% by mass to the total hole transport material amount, more preferably at least 90% by mass, and further preferably 100% by mass.

The hole transport material has a content of preferably at least 10 parts by mass and no greater than 200 parts by mass relative to 100 parts by mass of the binder resin in the photosensitive layer, and more preferably at least 50 parts by mass and no greater than 100 parts by mass. As a result of the content of the hole transport material being set to at least 10 parts by mass and no greater than 200 parts by mass, the photosensitive member of the present embodiment can have further effectively reduced environmental dependence of sensitivity and can further effectively inhibit occurrence of fogging in high-temperature and high-humidity environments.

### (Electron Transport Material)

Examples of the electron transport material include quinone-based compounds, diimide-based compounds, hydrazone-based compounds, malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroacridine, succinic anhydride, maleic anhydride, and dibromomaleic anhydride. Examples of the quinone-based compounds include diphenoquinone-based compounds, azoquinone-based compounds, anthraquinone-based compounds, naphthoquinone-based compounds, nitroanthraquinone-based compounds, and dinitroanthraquinone-based compounds.

The electron transport material includes at least one of compounds represented by formulas (11) to (17). In the following, the compounds represented by formulas (11) to (17) may be also referred to below as electron transport materials (11) to (17), respectively.

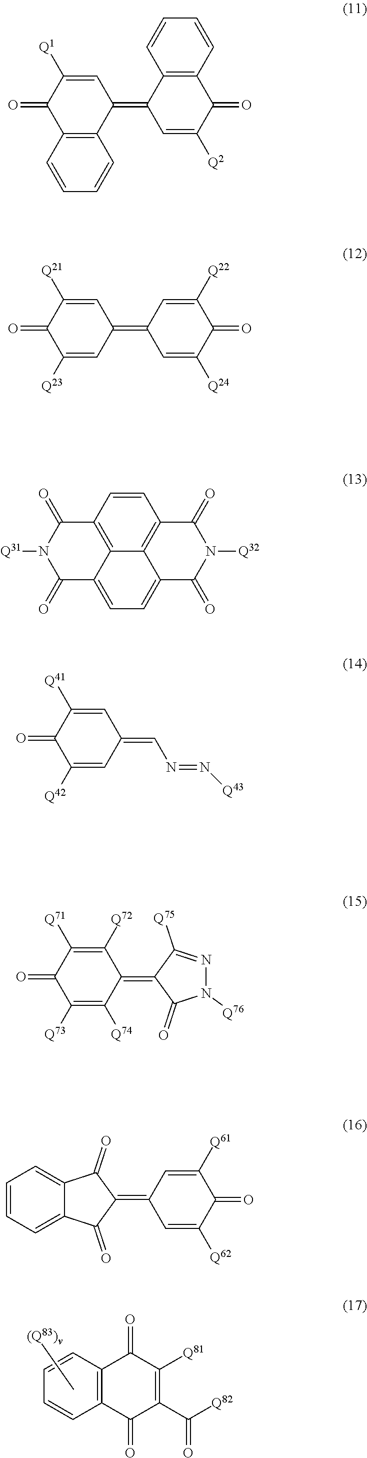

Q¹ and Q² in formula (11), Q²¹ Q²² Q²³, and Q²⁴ in formula (12), Q³¹ and Q³² in formula (13), Q⁴¹, Q⁴², and Q⁴³ in formula (14), Q⁷¹, Q⁷² Q⁷³ Q⁷⁴ Q⁷⁵, and Q⁷⁶ in formula (15), and Q⁶¹ and Q⁶² in formula (16) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one specific substituent. The specific substituent is at least one substituent selected from the group consisting of a halogen atom and an alkyl group with a carbon number of at least 1 and no greater than 6.

Preferably, Q¹ and Q² in formula (11) each represent, independently of one another, an alkyl group with a carbon number of at least 4 and no greater than 6. Preferably, Q²¹, Q²², Q²³, and Q²⁴ in formula (12) each represent, independently of one another, an alkyl group with a carbon number of at least 1 and no greater than 5. Preferably, Q³¹ and Q³² in formula (13) each represent, independently of one another, a phenyl group optionally substituted with an alkyl group with a carbon number of at least 1 and no greater than 3. Preferably, Q⁴¹ and Q⁴² in formula (14) each represent, independently of one another, an alkyl group with a carbon number of at least 3 and no greater than 5. Preferably, Q⁴³ in formula (14) represents a phenyl group optionally substituted with a halogen atom. Preferably, Q⁷¹ and Q⁷³ in formula (15) each represent, independently of one another, an alkyl group with a carbon number of at least 3 and no greater than 5. Preferably, Q⁷² and Q⁷⁴ in formula (15) each represent a hydrogen atom. Preferably, Q⁷⁵ in formula (15) represents a phenyl group or an alkyl group with a carbon number of at least 2 and no greater than 4. Preferably, Q⁷⁶ in formula (15) represents a phenyl group optionally substituted with a halogen atom or an alkyl group with a carbon number of at least 3 and no greater than 5. Preferably, Q⁶¹ and Q⁶² in formula (16) each represent, independently of one another, an alkyl group with a carbon number of at least 3 and no greater than 5.

In formula (17), Q⁸¹ represents an alkyl group with a carbon number of at least 1 and no greater than 6 or an aryl group with a carbon number of at least 6 and no greater than 14. Q⁸² represents an alkyl group with a carbon number of at least 1 and no greater than 6, an aryl group with a carbon number of at least 6 and no greater than 14, an alkoxy group with a carbon number of at least 1 and no greater than 6, an aralkyl group with a carbon number of at least 7 and no greater than 20, an aryloxy group with a carbon number of at least 6 and no greater than 14, or an aralkyloxy group with a carbon number of at least 7 and no greater than 20. Q⁸³ represents an alkyl group with a carbon number of at least 1 and no greater than 6. v represents an integer of at least 0 and on greater than 4. Preferably, Q⁸¹ represents a phenyl group. Preferably, Q⁸² represents an aralkyloxy group with a carbon number of at least 7 and no greater than 8. Preferably, Q⁸³ represents an alkyl group with a carbon number of at least 1 and no greater than 3. Preferably, v represents 0.

Preferably, the electron transport material includes at least one of compounds represented by formulas (ETM-1) to (ETM-8) (also referred to below as electron transport materials (ETM-1) to (ETM-8), respectively).

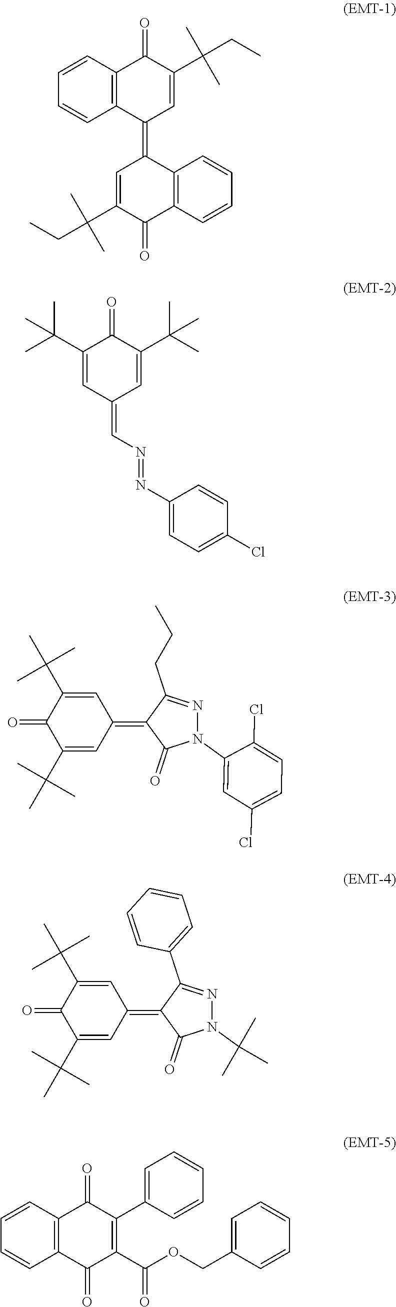

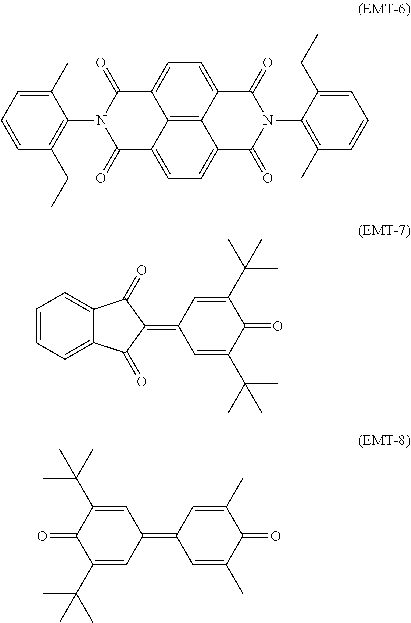

The total percentage content of any of the electron transport materials (11) to (17) is preferably at least 80% by mass to the total electron transport material amount, more preferably at least 90% by mass, and further preferably 100% by mass.

The electron transport material has a content of preferably at least 5 parts by mass and no greater than 150 parts by mass relative to 100 parts by mass of the binder resin in the photosensitive layer, and more preferably at least 20 parts by mass and no greater than 60 parts by mass. As a result of the content of the electron transport material being set to at least 5 parts by mass and no greater than 150 parts by mass, the photosensitive member of the present embodiment can have further effectively reduced environmental dependence of sensitivity and can further effectively inhibit occurrence of fogging in high-temperature and high-humidity environments.

### (Binder Resin)

Examples of the binder resin include thermoplastic resins (specific examples include polyarylate resin, polycarbonate resin, styrene-based resin, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins, polyamide resins, polyurethane resins, polysulfone resins, diallyl phthalate resins, ketone resins, polyvinyl butyral resins, polyvinyl acetal resins, and polyether resin), thermosetting resins (specific examples include silicone resins, epoxy resins, phenolic resins, urea resins, melamine resins, and crosslinkable thermosetting resins other than these), and photocurable resins (specific examples include epoxy-acrylic acid-based resins and urethane-acrylic acid-based copolymers).

Among these resins, a polycarbonate resin is preferable because single-layer photosensitive layers and charge transport layers can be obtained with an excellent balance of workability, mechanical strength, optical properties, and abrasion resistance. Examples of the polycarbonate resin include bisphenol Z polycarbonate resin, bisphenol B polycarbonate resin, bisphenol ZC polycarbonate resin, bisphenol C polycarbonate resin, and bisphenol A polycarbonate resin. The binder resin is preferably, but not particularly limited to, bisphenol Z polycarbonate resin. Bisphenol Z polycarbonate resin is a resin including a repeating unit represented by formula (BisZ).

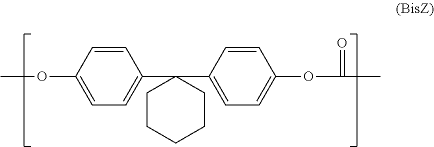

The binder resin has a percentage content of preferably at least 20% by mass and no greater than 60% by mass in the photosensitive layer, and more preferably at least 40% by mass and no greater than 50% by mass.

(n-Type Pigment)

Pigments are roughly divided into n-type pigments and p-type pigments. The n-type pigments are pigments in which the main charge carrier contains electrons. The p-type pigments are pigments in which the main charge carrier contains holes. The photosensitive layer of the photosensitive member of the present embodiment contains an n-type pigment. As a result of the photosensitive layer containing an n-type pigment, the photosensitive member of the present embodiment can have reduced environmental dependence of sensitivity and can inhibit occurrence of fogging in high-temperature and high-humidity environments.

Examples of the n-type pigment include azo pigments, perylene pigments, isoindoline pigments, polycyclic quinone-based pigments, squarylium-based pigments, pyranthrone-based pigments, perinone-based pigments, quinacridone-based pigments, pyrazolone-based pigments, and benzimidazolone-based pigments. The n-type pigment preferably includes at least one of an azo pigment, a perylene pigment, and an isoindoline pigment. The total percentage content of any of the azo pigment, the perylene pigment, and the isoindoline pigment is preferably at least 90% by mass to the total n-type pigment amount, and more preferably 100% by mass.

The azo pigment is described below. The azo pigment is a pigment having an azo group (—N═N—). Examples of the azo pigment include monoazo pigments and polyazo pigments (e.g., bisazo pigment, tris-azo pigment, and tetrakisazo pigment). The azo pigment may be a tautomer. The azo pigment may also have a chlorine atom (chloro group) in addition to the azo group.

The azo pigment may be a known azo pigment, for example. Preferable examples of the azo pigment include Pigment Yellow (14, 17, 49, 65, 73, 83, 93, 94, 95, 128, 166, or 77), Pigment Orange (1, 2, 13, 34, or 36), and Pigment Red (30, 32, 61, or 144).

Preferably, the azo pigment includes compounds represented by formulas (Az1) to (Az5) (also referred to below as n-type pigments (Az1) to (Az5) respectively)

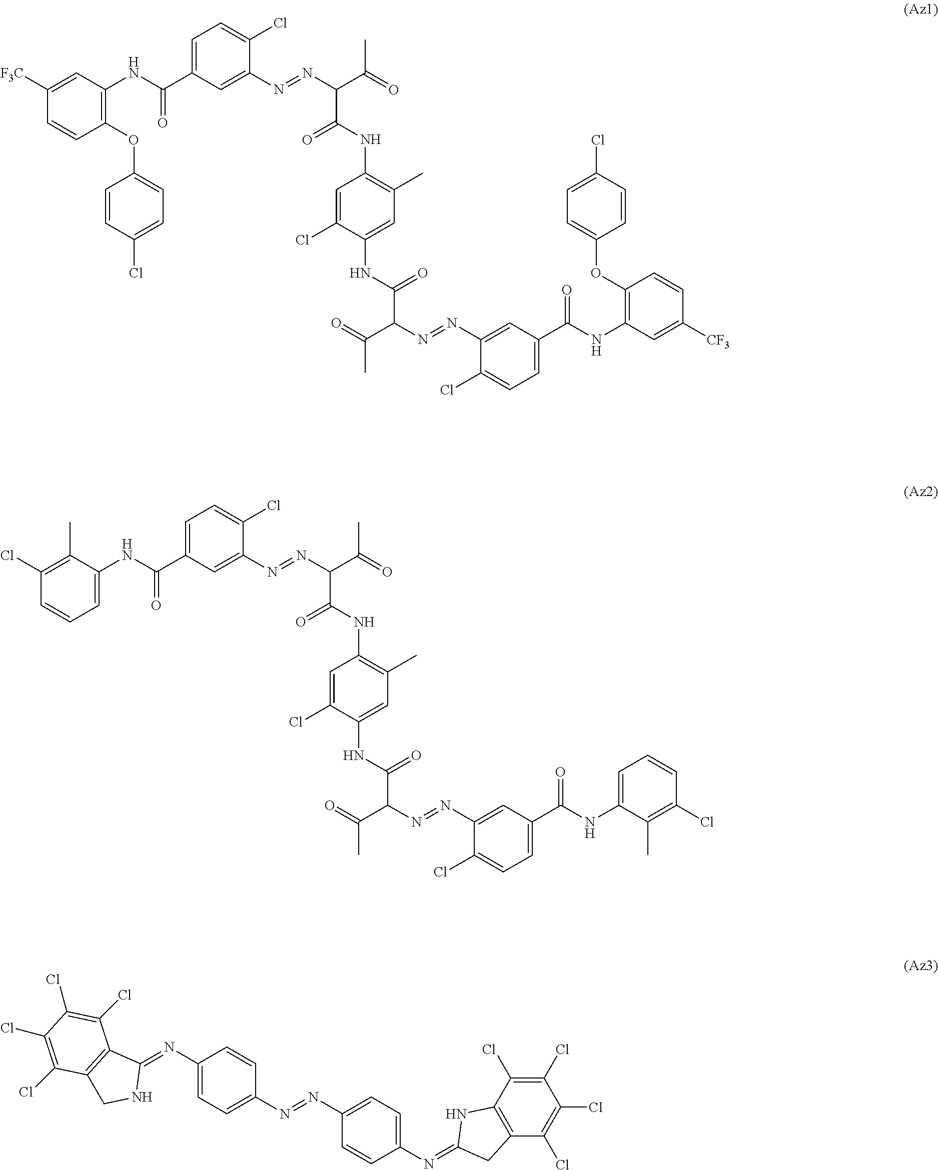 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C ; CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C ; Clc1c(Cl)c(Cl)c2c(c1Cl)C/C(=N/c1ccc(/N=N/c3ccc(/N=C4\NCc5c(Cl)c(Cl)c(Cl)c(Cl)c54)cc3)cc1)N2]

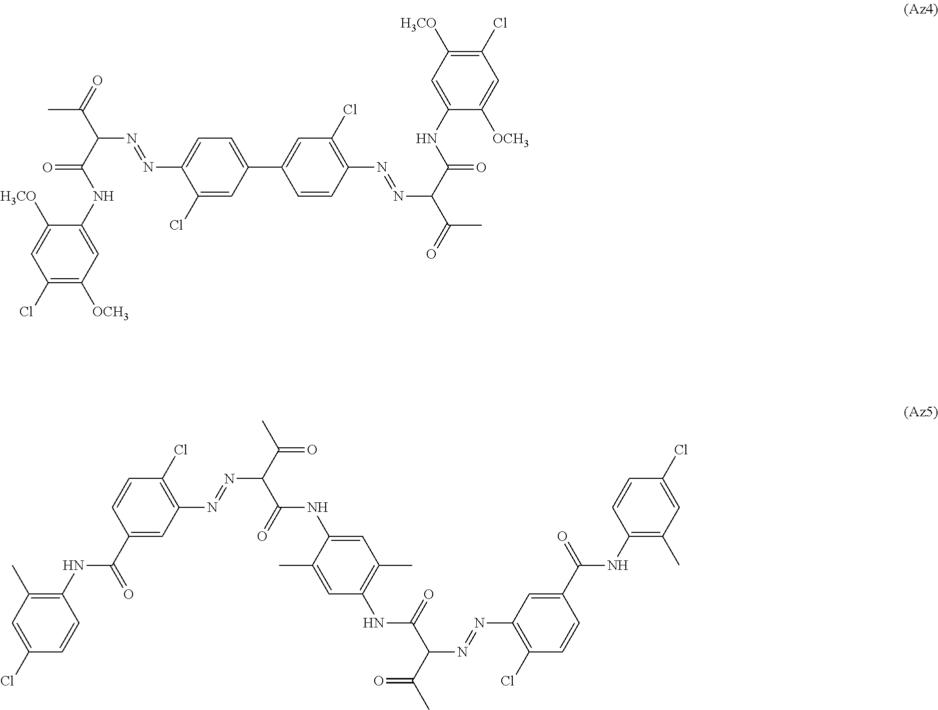 [SMILES: COc1cc(NC(=O)C(/N=N/c2ccc(-c3ccc(/N=N/C(C(C)=O)C(=O)Nc4cc(OC)c(Cl)cc4OC)c(Cl)c3)cc2Cl)C(C)=O)c(OC)cc1Cl ; CC(=O)C(/N=N/c1cc(C(=O)Nc2ccc(Cl)cc2C)ccc1Cl)C(=O)Nc1cc(C)c(NC(=O)C(/N=N/c2cc(C(=O)Nc3ccc(Cl)cc3C)ccc2Cl)C(C)=O)cc1C]

The perylene pigment is described next. The perylene pigment has a perylene skeleton represented by formula (P-I), for example. In formula (P-I), Q⁹⁰ and Q⁹¹ each represent, independently of one another, a divalent organic group.

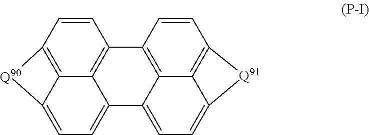

A first specific example of the perylene pigment is a perylene pigment represented by formula (P-II).

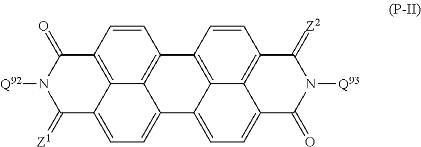

In formula (P-II), Q⁹² and Q⁹³ each represent, independently of one another, a hydrogen atom or a monovalent organic group. Z¹ and Z² each represent, independently of one another, an oxygen atom or a nitrogen atom. Z¹ and Z² preferably represent the same group as each other, and more preferably each represent an oxygen atom. Preferably, Q⁹² and Q⁹³ represent the same group as each other.

Examples of the monovalent organic group that Q⁹² or Q⁹³ represent in formula (P-II) include an alkyl group, a cycloalkyl group, an alkoxy group, an aralkyl group optionally substituted with a substituent, an aryl group optionally substituted with a substituent, and a heterocyclic group optionally substituted with a substituent. The monovalent organic group that Q⁹² or Q⁹³ represent is preferably an alkyl group or an aryl group optionally substituted with a substituent.

Preferable examples of the substituent that optionally substitutes any of the aralkyl group, the aryl group, and the heterocyclic group represented by Q⁹² or Q⁹³ include a phenyl group, a halogen atom, a hydroxy group, a cyano group, a nitro group, a phenylazo group, an alkyl group with a carbon number of at least 1 and no greater than 6, or an alkoxy group with a carbon number of at least 1 and no greater than 6. An alkyl group with a carbon number of at least 1 and no greater than 3 (particularly, a methyl group) is more preferable.

The alkyl group represented by Q⁹² or Q⁹³ is preferably an alkyl group with a carbon number of at least 1 and no greater than 6, more preferably an alkyl group with a carbon number of at least 1 and no greater than 3, and further preferably a methyl group.

The aryl group optionally substituted with a substituent and represented by Q⁹² or Q⁹³ is preferably an aryl group with a carbon number of at least 6 and no greater than 14 optionally substituted with a substituent, more preferably an aryl group with a carbon number of at least 6 and no greater than 10 optionally substituted with a substituent, further preferably a phenyl group optionally substituted with a substituent, and particularly preferably a phenyl group or a xylyl group (especially, 3,5-xylyl group).

A second specific example of the perylene pigment is a compound represented by formula (P-III).

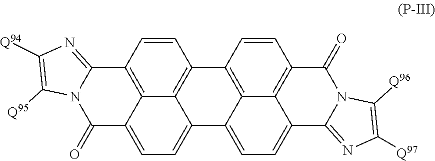

In formula (P-III), Q⁹⁴ to Q⁹⁷ each represent, independently of one another, a hydrogen atom or a monovalent organic group. Q⁹⁴ and Q⁹⁵ may bond to each other to form a ring. Q⁹⁶ and Q⁹⁷ may bond to each other to form a ring.

The monovalent organic group represented by any of Q⁹⁴ to Q⁹⁷ in formula (P-III) is defined the same as the monovalent organic group represented by any of Q⁹² and Q⁹³ in formula (P-II).

Examples of the ring formed by Q⁹⁴ and Q⁹⁵ bonding to each other and the ring formed by Q⁹⁶ and Q⁹⁷ bonding to each other include aromatic hydrocarbon rings, aromatic heterocyclic rings, alicyclic hydrocarbon rings, and alicyclic heterocyclic rings. Preferable examples of the ring formed by Q⁹⁴ and Q⁹⁵ bonding to each other and the ring formed by Q⁹⁶ and Q⁹⁷ bonding to each other include a benzene ring, a naphthalene ring, a pyridine ring, and a tetrahydronaphthalene ring, and a more preferable example is a benzene ring. The benzene ring or the naphthalene ring formed by Q⁹⁴ and Q⁹⁵ bonding to each other is condensed with an imidazole ring to which Q⁹⁴ and Q⁹⁵ are bonded. The benzene ring or the naphthalene ring formed by Q⁹⁶ and Q⁹⁷ bonding to each other is condensed with an imidazole ring to which Q⁹⁶ and Q⁹⁷ are bonded.

The ring formed by Q⁹⁴ and Q⁹⁵ bonding to each other and the ring formed by Q⁹⁶ and Q⁹⁷ bonding to each other may each be substituted with a substituent. The substituent such as above is preferably a halogen atom, and more preferably a chlorine atom or a fluorine atom.

In formula (P-III), Q⁹⁴ and Q⁹⁵ preferably bond to each other to form an unsubstituted benzene ring. Q⁹⁶ and Q⁹⁷ preferably bond to each other to form an unsubstituted benzene ring.

The perylene pigment preferably includes compounds represented by any of formulas (P1) to (P4) (also referred to below as n-type pigments (P1) to (P4), respectively).

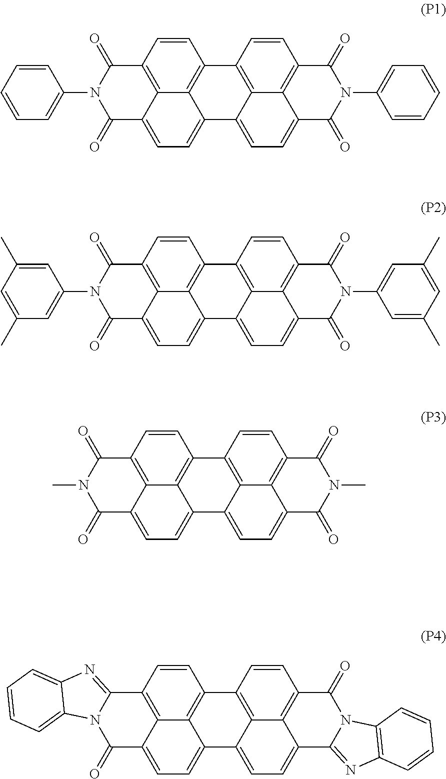

The isoindoline pigment is described next. The isoindoline pigment is a pigment having an isoindoline structure. The isoindoline structure is a structure represented by formula (IA). A substituent may be bonded to a carbon atom of the structure represented by formula (IA).

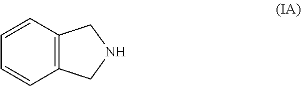

The isoindoline pigment preferably includes any of compounds represented by formulas (I1) and (I2) (also referred to below as n-type pigments (I1) and (I2), respectively).

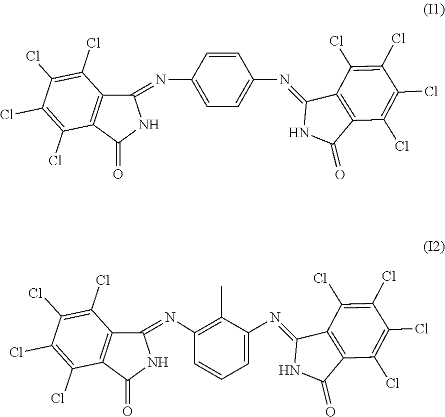 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21 ; Cc1c(/N=C2\NC(=O)c3c(Cl)c(Cl)c(Cl)c(Cl)c32)cccc1/N=C1\NC(=O)c2c(Cl)c(Cl)c(Cl)c(Cl)c21]

As described above, the n-type pigment preferably includes at least one of the n-type pigments (Az1) to (Az5), (P1) to (P4), (I1), and (I2). The total percentage content of any of the n-type pigments (Az1) to (Az5), (P1) to (P4), (I1), and (I2) is preferably at least 90% by mass to the total n-type pigment amount, and more preferably 100% by mass.

The n-type pigment has a content of preferably at least 0.5 parts by mass and no greater than 20.0 parts by mass relative to 100 parts by mass of the binder resin in the photosensitive layer, more preferably at least 1.5 parts by mass and no greater than 10.0 parts by mass, and further preferably at least 2.0 parts by mass and no greater than 4.5 parts by mass. The n-type pigment has a content of at least 20 parts by mass and no greater than 1000 parts by mass relative to 100 parts by mass of the charge generating material in the photosensitive layer, and more preferably at least 40 parts by mass and no greater than 250 parts by mass, and further preferably at least 50 parts by mass and no greater than 100 parts by mass. As a result of the content of the n-type pigment being set in the above ranges, the photosensitive member of the present embodiment can have further effectively reduced environmental dependence of sensitivity and can further effectively inhibit occurrence of fogging in high-temperature and high-humidity environments.

### (Additive)

Examples of the additive contained in the photosensitive layer include an ultraviolet absorbing agent, an antioxidant, a radical scavenger, a singlet quencher, a softener, a surface modifier, an extender, a thickener, a dispersion stabilizer, a wax, a donor, a surfactant, a plasticizer, a sensitizer, an electron acceptor compound, and a leveling agent. Example of the leveling agent include silicone oils, and a specific example thereof is dimethyl silicone oil.

The photosensitive layer preferably contains a silicone oil. In this case, the content of the silicone oil is preferably at least 0.01 parts by mass and no greater than 0.5 parts by mass relative to 100 parts by mass of the binder resin in the photosensitive layer.

### [Conductive Substrate]

The conductive substrate is not particularly limited so long as at least a surface portion thereof is constituted by a conductive material. An example of the conductive substrate is a conductive substrate constituted by a conductive material. Another example of the conductive substrate is a conductive substrate covered with a conductive material. Examples of the conductive material include aluminum, iron, copper, tin, platinum, silver, vanadium, molybdenum, chromium, cadmium, titanium, nickel, palladium, and indium. An alloy (specific examples include aluminum alloys, stainless steel, and brass) may be used by combining two or more conductive materials. In terms of achieving favorable charge mobility from the photosensitive layer to the conductive substrate, the conductive material is preferably aluminum or an aluminum alloy. The shape of the conductive substrate is appropriately selected according to the configuration of an image forming apparatus that includes the conductive substrate. The conductive substrate can be in the shape of a sheet or a drum, for example. The thickness of the conductive substrate is appropriately selected according to the shape of the conductive substrate.

### [Photosensitive Member Production Method]

An example of a method for producing the photosensitive member of the present embodiment is described next. The photosensitive member production method includes an intermediate layer formation process and a photosensitive layer formation process, for example.

### (Intermediate Layer Formation Process)

In the intermediate layer formation process, an application liquid (also referred to below as an application liquid for intermediate layer formation) for forming the intermediate layer is prepared. The application liquid for intermediate layer formation contains the specific inorganic particles, the specific polyamide resin, and a solvent. Next, the application liquid for intermediate layer formation is applied onto the conductive substrate. Next, at least a portion of the solvent contained in the applied application liquid for intermediate layer formation is removed to form the intermediate layer.

### (Photosensitive Layer Formation Process)

In the photosensitive layer formation process, an application liquid (also referred to below as an application liquid for photosensitive layer formation) for forming the photosensitive layer is prepared. The application liquid for photosensitive layer formation contains the charge generating material, the electron transport material, the binder resin, the hole transport material, the n-type pigment, a solvent, and an optional component (e.g., an additive), for example. The application liquid for photosensitive layer formation is prepared by mixing the above components. Next, the application liquid for photosensitive layer formation is applied onto the intermediate layer. Next, at least a portion of the solvent contained in the application liquid for photosensitive layer formation is removed to form the photosensitive layer.

The solvents contained in the application liquid for intermediate layer formation and the application liquid for photosensitive layer formation (also referred to below collectively as application liquids) are not limited particularly so long as they can dissolve or disperse each component contained in the respective application liquids. Examples of the solvents include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include methylene chloride, chloroform, ethylene chloride, dichloromethane, dichloroethane, carbon tetrachloride, and chlorobenzene), ethers (specific examples include dioxane, dimethyl ether, diethyl ether, tetrahydrofuran, ethylene glycol dimethyl ether, propylene glycol monomethyl ether, and diethylene glycol dimethyl ether), ketones (specific examples include acetone, methyl ethyl ketone, 2-butanone, and cyclohexanone), esters (specific examples include ethyl acetate and methyl acetate), dimethyl formaldehyde, dimethyl formamide, and dimethyl sulfoxide.

The application liquids are prepared by mixing the corresponding components to dissolve or disperse the components in the respective solvents. Mixing can be performed using for example a bead mill, a ball mill, a roll mill, a paint shaker, or an ultrasonic disperser.

A method for applying the application liquids is not limited particularly as long as it can achieve uniform application of the application liquids. Examples of the application method include dip coating, spray coating, bead coating, blade coating, and roller coating.

The method for removing at least a portion of the solvent contained in the application liquid for intermediate layer formation or the application liquid for photosensitive layer formation may be heating, pressure reduction, or a combination of heating and pressure reduction, for example. A specific example is thermal treatment (hot air drying) using a high-temperature dryer or a vacuum dryer. The temperature of the thermal treatment is at least 40° C. and no greater than 150° C., for example. The time for the thermal treatment is at least 3 minutes and no greater than 150 minutes, for example.

### [Preferable Constitution of Photosensitive Member]

The photosensitive member of the present embodiment preferably has any of constitutions (1) to (38) shown in Tables 2 and 3. Note that the terms in Tables 2 and 3 are as follows.
CGM: charge generating material
CGM-1: Y-form titanyl phthalocyanine
HTM: hole transport material
ETM: electron transport material
BisZ: bisphenol Z polycarbonate resin

In Tables 2 and 3, Constitution (1), for example, means a photosensitive member in which an intermediate layer contains the specific inorganic particle (t1) and the polyamide resin (a1) and a photosensitive layer contains Y-form titanyl phthalocyanine, the n-type pigment (Az1), the hole transport material (HTM-1), the electron transport material (ETM-1), and bisphenol Z polycarbonate resin.

TABLE 2

| | Intermediate layer | | Photosensitive layer | | | | |
|---|---|---|---|---|---|---|---|
| | Specific inorganic | Polyamide | | n-type | | | Binder |
| Constitution | particles | resin | CGM | pigment | HTM | ETM | resin |
| 1 | t1 | a1 | CGM-1 | Az1 | HTM-1 | ETM-1 | BisZ |
| 2 | t1 | a2 | CGM-1 | Az1 | HTM-1 | ETM-1 | BisZ |
| 3 | t1 | a3 | CGM-1 | Az1 | HTM-1 | ETM-1 | BisZ |
| 4 | t1 | a4 | CGM-1 | Az1 | HTM-1 | ETM-1 | BisZ |
| 5 | t2 | a1 | CGM-1 | Az1 | HTM-1 | ETM-1 | BisZ |
| 6 | t3 | a1 | CGM-1 | Az1 | HTM-1 | ETM-1 | BisZ |
| 7 | t4 | a1 | CGM-1 | Az1 | HTM-1 | ETM-1 | BisZ |
| 8 | t5 | a1 | CGM-1 | Az1 | HTM-1 | ETM-1 | BisZ |
| 9 | t6 | a1 | CGM-1 | Az1 | HTM-1 | ETM-1 | BisZ |
| 10 | t7 | a1 | CGM-1 | Az1 | HTM-1 | ETM-1 | BisZ |
| 11 | t1 | a1 | CGM-1 | Az2 | HTM-1 | ETM-1 | BisZ |
| 12 | t1 | a1 | CGM-1 | Az3 | HTM-1 | ETM-1 | BisZ |
| 13 | t1 | a1 | CGM-1 | Az4 | HTM-1 | ETM-1 | BisZ |
| 14 | t1 | a1 | CGM-1 | Az5 | HTM-1 | ETM-1 | BisZ |
| 15 | t1 | a1 | CGM-1 | P1 | HTM-1 | ETM-1 | BisZ |
| 16 | t1 | a1 | CGM-1 | P2 | HTM-1 | ETM-1 | BisZ |
| 17 | t1 | a1 | CGM-1 | P3 | HTM-1 | ETM-1 | BisZ |
| 18 | t1 | a1 | CGM-1 | P4 | HTM-1 | ETM-1 | BisZ |
| 19 | t1 | a1 | CGM-1 | I1 | HTM-1 | ETM-1 | BisZ |
| 20 | t1 | a1 | CGM-1 | I2 | HTM-1 | ETM-1 | BisZ |

TABLE 3

| | Intermediate layer | | Photosensitive layer | | | | |
|---|---|---|---|---|---|---|---|
| | Specific inorganic | | | n-type | | | Binder |
| Constitution | particles | Polyamide resin | CGM | pigment | HTM | ETM | resin |
| 21 | t1 | a1 | CGM-1 | Az1 | HTM-2 | ETM-1 | BisZ |
| 22 | t1 | a1 | CGM-1 | Az1 | HTM-3 | ETM-1 | BisZ |
| 23 | t1 | a1 | CGM-1 | Az1 | HTM-4 | ETM-1 | BisZ |
| 24 | t1 | a1 | CGM-1 | Az1 | HTM-5 | ETM-1 | BisZ |
| 25 | t1 | a1 | CGM-1 | Az1 | HTM-6 | ETM-1 | BisZ |
| 26 | t1 | a1 | CGM-1 | Az1 | HTM-7 | ETM-1 | BisZ |
| 27 | t1 | a1 | CGM-1 | Az1 | HTM-8 | ETM-1 | BisZ |
| 28 | t1 | a1 | CGM-1 | Az1 | HTM-9 | ETM-1 | BisZ |
| 29 | t1 | a1 | CGM-1 | Az1 | HTM-10 | ETM-1 | BisZ |
| 30 | t1 | a1 | CGM-1 | Az1 | HTM-11 | ETM-1 | BisZ |
| 31 | t1 | a1 | CGM-1 | Az1 | HTM-12 | ETM-1 | BisZ |
| 32 | t1 | a1 | CGM-1 | Az1 | HTM-1 | ETM-2 | BisZ |
| 33 | t1 | a1 | CGM-1 | Az1 | HTM-1 | ETM-3 | BisZ |
| 34 | t1 | a1 | CGM-1 | Az1 | HTM-1 | ETM-4 | BisZ |
| 35 | t1 | a1 | CGM-1 | Az1 | HTM-1 | ETM-5 | BisZ |
| 36 | t1 | a1 | CGM-1 | Az1 | HTM-1 | ETM-6 | BisZ |
| 37 | t1 | a1 | CGM-1 | Az1 | HTM-1 | ETM-7 | BisZ |
| 38 | t1 | a1 | CGM-1 | Az1 | HTM-1 | ETM-8 | BisZ |

### Second Embodiment: Image Forming Apparatus

A second embodiment of the present disclosure relates to an image forming apparatus. The image forming apparatus includes an image bearing member, a charger that charges the surface of the image bearing member, a light exposure device that exposes the charged surface of the image bearing member to light to form an electrostatic latent image on the surface of the image bearing member, a development device that develops the electrostatic latent image into a toner image by supplying toner to the surface of the image bearing member, and a transfer device that transfers the toner image from the image bearing member to a transfer target. The image bearing member is the electrophotographic photosensitive member described in the first embodiment.

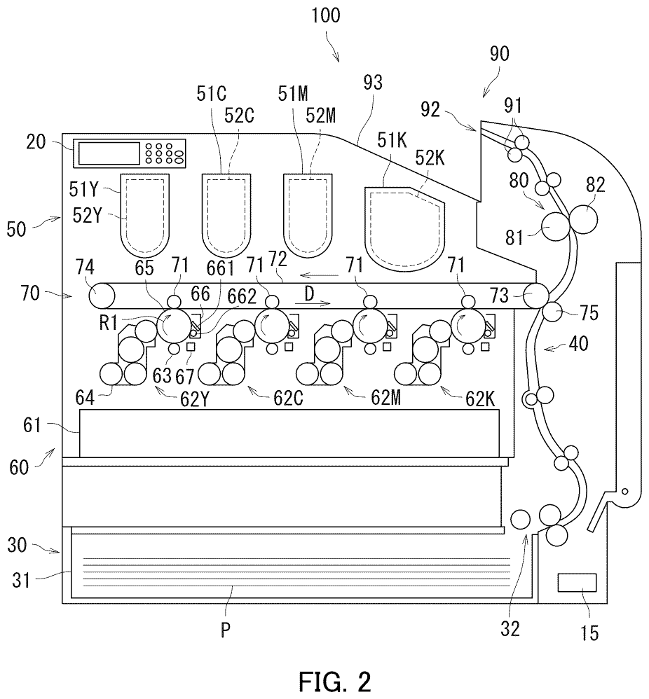

With reference to FIG. 2, an image forming apparatus 100 is described which is an example of the image forming apparatus of the present embodiment. FIG. 2 is a diagram illustrating an example of the configuration of the image forming apparatus 100. The image forming apparatus 100 is a tandem color printer, for example.

As illustrated in FIG. 2, the image forming apparatus 100 includes a controller 15, an operation section 20, a sheet feed section 30, a conveyance section 40, a toner replenishing section 50, an image forming section 60, a transfer device 70, a fixing device 80, and an ejection section 900.

The controller 15 controls operation of each element included in the image forming apparatus 100. The controller 15 includes a processor (not illustrated) and storage (not illustrated). The processor includes a central processing unit (CPU), for example. The storage include memory such as semiconductor memory, and may include a hard disk drive (HDD). The processor executes control programs to control the operation of the image forming apparatus 100. The storage stores the control programs therein.

The operation section 20 receives instructions from a user. Once receiving an instruction from the user, the operation section 20 transmits a signal indicating the instruction from the user to the controller 15. As a result, the image forming apparatus 100 starts image formation.

The sheet feed section 30 includes a sheet feed cassette 31 and a sheet feed roller group 32. The sheet feed cassette 31 accommodates multiple sheets P of recording medium (e.g., paper). The sheet feed roller group 32 feeds each sheet P, which is accommodated in the sheet feed cassette 31, to the conveyance section 40 one at a time.

The conveyance section 40 includes a roller and a guide member. The conveyance section 40 extends from the sheet feed section 30 to the ejection section 90. The conveyance section 40 conveys the sheet P from the sheet feed section 30 to the ejection section 90 via the image forming section 60 and the fixing device 80.

The toner replenishing section 50 replenishes the image forming section 60 with toners. The toner replenishing section 50 includes a first fitting portion 51Y, a second fitting portion 51C, a third fitting portion 51M, and a fourth fitting portion 51K.

A first toner container 52Y is fitted to the first fitting portion 51Y Likewise, a second toner container 52C is fitted to the second fitting portion 51C, a third toner container 52M is fitted to the third fitting portion 51M, and a fourth toner container 52K is fitted to the fourth fitting portion 51K.

The first toner container 52Y, the second toner container 52C, the third toner container 52M, and the fourth toner container 52K each accommodate a toner. The first toner container 52Y accommodates a yellow toner. The second toner container 52C accommodates a cyan toner. The third toner container 52M accommodates a magenta toner. The fourth toner container 52K accommodates a black toner.

The image forming section 60 includes a light exposure device 61, a first image forming unit 62Y, a second image forming unit 62C, a third image forming unit 62M, and a fourth image forming unit 62K.

The first image forming unit 62Y to the fourth image forming unit 62K each include a charger 63, a development device 64, an image bearing member 65, a cleaner 66, and a static eliminator 67.

Note that the configurations of the first image forming unit 62Y to the fourth image forming unit 62K are the same as one another except that the types of toner replenished by the toner replenishing section 50 differ from one another. Therefore, reference signs for elements of the second image forming unit 62C to the fourth image forming unit 62K are omitted in FIG. 2.

Each of the image bearing members 65 is the photosensitive member (specifically, the photosensitive member 1) of the first embodiment. As described above, the photosensitive member of the first embodiment can have reduced environmental dependence of sensitivity and can inhibit occurrence of fogging in high-temperature and high-humidity environments. Therefore, the image forming apparatus 100 can have reduced environmental dependence of sensitivity and can inhibit occurrence of fogging in high-temperature and high-humidity environments.

The image bearing member 65 rotates in the direction (clockwise direction in FIG. 2) indicated by an arrow R1 in FIG. 2. The charger 63, the development device 64, the cleaner 66, and the static eliminator 67 are arranged along the circumferential surface of the image bearing member 65 in the stated order from upstream in the direction of rotation of the image bearing member 65.

The charger 63 charges the surface (circumferential surface) of the image bearing member 65. The charger 63 uniformly charges the image bearing member 65 to a specific polarity by discharging. The charger 63 is a charging roller, for example.

The light exposure device 61 exposes the charged surface of the image bearing member 65 to light. In detail, the light exposure device 61 irradiates the charged surface of the image bearing member 65 with laser light. In the manner described above, an electrostatic latent image is formed on the surface of the image bearing member 65.

The development device 64 is replenished with a toner by the toner replenishing section 50. The development device 64 supplies the toner replenished by the toner replenishing section 50 to the surface of the image bearing member 65. As a result, the electrostatic latent image formed on the surface of the image bearing member 65 is developed into a toner image.

The development device 64 of the first image forming unit 62Y is connected to the first toner container 52Y In the above configuration, the development device 64 of the first image forming unit 62Y is replenished with the yellow toner. A yellow toner image is accordingly formed on the surface of the image bearing member 65 of the first image forming unit 62Y.

Likewise, the development device 64 of the second image forming unit 62C, the development device 64 of the third image forming unit 62M, and the development device 64 of the fourth image forming unit 62K are connected to the second toner container 52C, the third toner container 52M, and the fourth toner container 52K, respectively. In the above configuration, the development device 64 of the second image forming unit 62C, the development device 64 of the third image forming unit 62M, and the development device 64 of the fourth image forming unit 62K are replenished with the cyan toner, the magenta toner, and the black toner, respectively. A cyan toner image, a magenta toner image, and a black toner image are accordingly formed on the surface of the image bearing member 65 of the second image forming unit 62C, the surface of the image bearing member 65 of the third image forming unit 62M, and the surface of the image bearing member 65 of the fourth image forming unit 62K, respectively.

The cleaner 66 includes a cleaning member 661 and a rubbing roller 662. After transfer by a later-described primary transfer roller 71, the cleaning member 661 is pressed against the surface of the image bearing member 65 to collect toner attached to the surface of the image bearing member 65. The cleaning member 661 is a cleaning blade, for example. The rubbing roller 662 rubs the surface of the image bearing member 65 to polish the surface of the image bearing member 65.

The static eliminator 67 irradiates the surface of the image bearing member 65 with static elimination light to remove static on the surface of the image bearing member 65.

The transfer device 70 transfers the toner image from the image bearing member 65 to the sheet P being a transfer target. In detail, the transfer device 70 transfers the toner images formed on the respective surfaces of the image bearing members 65 of the first image forming unit 62Y to the fourth image forming unit 62K to the sheet P in a superimposed manner. The transfer device 70 transfers the toner images to the sheet P in a superimposed manner by the secondary transfer process (intermediate transfer process). The transfer device 70 includes four primary transfer rollers 71, an intermediate transfer belt 72, a drive roller 73, a driven roller 74, and a secondary transfer roller 75.

The intermediate transfer belt 72 is an endless belt wound around the four primary transfer rollers 71, the drive roller 73, and the driven roller 74. The intermediate transfer belt 72 is driven following rotation of the drive roller 73. The intermediate transfer belt 72 circulates anticlockwise in FIG. 2. The driven roller 74 is rotationally driven by driving the intermediate transfer belt 72.

The first image forming unit 62Y to the fourth image forming unit 62K are arranged opposite to the lower surface of the intermediate transfer belt 72. The first image forming unit 62Y to the fourth image forming unit 62K are arranged in the order of the first image forming unit 62Y to the fourth image forming unit 62K from upstream to downstream in a driving direction D of the lower surface of the intermediate transfer belt 72.

The primary transfer rollers 71 are each placed opposite to a corresponding one of the image bearing members 65 with the intermediate transfer belt 72 therebetween and each are pressed toward a corresponding one of the image bearing members 65. In the above configuration, the toner images formed on the surfaces of the image bearing members 65 are sequentially transferred to the intermediate transfer belt 72 by the respective primary transfer rollers 71. The yellow toner image, the cyan toner image, the magenta toner image, and the black toner image are transferred to the intermediate transfer belt 72 in the stated order in a superimposed manner. In the following, a toner image obtained by superimposing the yellow toner image, the cyan toner image, the magenta toner image, and the black toner image may be also referred to below as a “layered toner image”.

The secondary transfer roller 75 is placed opposite to the drive roller 73 with the intermediate transfer belt 72 therebetween. The secondary transfer roller 75 is pressed toward the drive roller 73. In the above configuration, a transfer nip is formed between the secondary transfer roller 75 and the drive roller 73. When the sheet P passes through the transfer nip, the layered toner image on the intermediate transfer belt 72 is transferred to the sheet P by the secondary transfer roller 75. The yellow toner image, the cyan toner image, the magenta toner image, and the black toner image are transferred to the sheet P in the stated order, with the upper layer becoming the lower layer. The sheet P with the layered toner image transferred thereto is conveyed to the fixing device 80 by the conveyance section 40.

The fixing device 80 includes a heating member 81 and a pressure member 82. The heating member 81 and the pressure member 82 are arranged opposite to each other to form a fixing nip. As the sheet P conveyed from the image forming section 60 passes through the fixing nip, it is pressed and heated at a specific fixing temperature. As a result, the layered toner image is fixed to the sheet P. The sheet P is conveyed from the fixing device 80 to the ejection section 90 by the conveyance section 40.

The ejection section 90 includes an ejection roller pair 91 and an exit tray 93. The ejection roller pair 91 conveys the sheet P to the exit tray 93 through an exit port 92. The exit port 92 is formed in an upper part of the image forming apparatus 100.

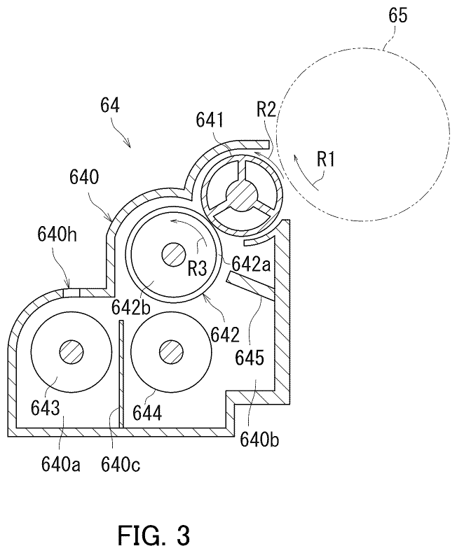

The configuration of an development device 64 is described next in detail with reference to FIG. 3. FIG. 3 is a diagram illustrating an example of the configuration of an development device 64. In detail, FIG. 3 illustrates the development device 64 of the first image forming unit 62Y Note that the corresponding image bearing member 65 is indicated by a dashed and double dotted line in FIG. 3 for ease of understanding. The development device 64 adopts the touchdown development system and the two-component development process using a two-component developer.

As has been described with reference to FIG. 2, the developer container 640 of the development device 64 is connected to the first toner container 52Y In the above configuration, the developer container 640 of the development device 64 is replenished with the yellow toner through a toner replenishment port 640h.

As illustrated in FIG. 3, the development device 64 includes, in the interior of the developer container 640, a development roller 641, a magnetic roller 642, a first stirring screw 643, a second stirring screw 644, and a blade 645. In detail, the development roller 641 is placed opposite to the magnetic roller 642. The magnetic roller 642 is placed opposite to the second stirring screw 644. The blade 645 is placed opposite to the magnetic roller 642.

The developer container 640 is divided into a first stirring chamber 640a and a second stirring chamber 640b by a partition wall 640c. The partition wall 640c extends in the axial direction of the development roller 641. The first stirring chamber 640a and the second stirring chamber 640b communicate with each other outside the opposite ends of the partition wall 640c in the longitudinal direction thereof.

The first stirring screw 643 is placed in the first stirring chamber 640a. The first stirring chamber 640a accommodates a carrier being a magnetic carrier. The first stirring chamber 640a is replenished with a toner being a non-magnetic toner through the toner replenishment port 640h. In the example illustrated in FIG. 3, the first stirring chamber 640a is replenished with the yellow toner.

The second stirring screw 644 is placed in the second stirring chamber 640b. The second stirring chamber 640b accommodates the carrier being magnetic.

The yellow toner and the carrier are stirred by the first stirring screw 643 and the second stirring screw 644. As a result, a two-component developer is made up of the carrier and the yellow toner. Thus, the developer container 640 (specifically, the first stirring chamber 640a and the second stirring chamber 640b) accommodates the two-component developer.

The first stirring screw 643 and the second stirring screw 644 stir while circulating the two-component developer between the first stirring chamber 640a and the second stirring chamber 640b. As a result, the toner is charged to a specific polarity by friction with the carrier.

Note that the toner and the surface of the image bearing member 65 are charged to a positive polarity, for example.

The magnetic roller 642 includes a non-magnetic rotation sleeve 642a and a magnet 642b. The magnet 642b is placed and fixed inside the rotation sleeve 642a. The magnet 642b has a plurality of magnetic poles. The two-component developer is adsorbed to the magnetic roller 642 by the magnetic force of the magnet 642b. As a result, a magnetic brush is formed on the surface of the magnetic roller 642.

The blade 645 is placed upstream in the direction of rotation of the magnetic roller 642 relative to the location where the magnetic roller 642 and the development roller 641 are opposite to each other. The magnetic roller 642 rotates in the direction (anticlockwise direction in FIG. 3) indicated by an arrow R³ in FIG. 3. The magnetic roller 642 rotates to convey the magnetic brush to a location opposite to the blade 645. The blade 645 is placed to form a gap between the blade 645 and the magnetic roller 642. The blade 645 is constituted by a magnet. In the above configuration, the thickness of the magnetic brush is restricted by the magnetic force of the blade 645.

Once the thickness of the magnetic brush on the magnetic roller 642 is restricted, a specific level of voltage is applied to the magnetic roller 642 and the development roller 641. When the potential difference between the magnetic roller 642 and the development roller 641 reaches a specific level by application of the specific level of voltage, the yellow toner contained in the two-component developer moves to the development roller 641. As a result, a toner thin layer of the yellow toner is formed on the surface of the development roller 641.

The development roller 641 rotates in the direction (anticlockwise direction in FIG. 4) indicated by an arrow R2 in FIG. 3. This conveys the toner thin layer formed on the surface of the development roller 641 to a location opposite to the image bearing member 65 and attaches the toner thin layer to the image bearing member 65. In the manner described above, the development device 64 supplies the toner charged by friction with the carrier to the surface of the image bearing member 65.

The development device 64 of the first image forming unit 62Y has been described so far with reference to FIG. 3. The configurations of the development devices 64 of the first image forming unit 62Y to the fourth image forming unit 62K are the same as each other in all aspects other than the types of toner replenished by the toner replenishing section 50. Therefore, descriptions is omitted of the configurations of the development devices 64 of the second image forming unit 62C to the fourth image forming unit 62K.

The image forming apparatus 100, which is an example of the image forming apparatus of the present embodiment, has been descried so far with reference to FIGS. 2 and 3. However, the image forming apparatus of the present embodiment is not limited to the image forming apparatus 100. For example, the image forming apparatus may be a monochrome image forming apparatus. In this case, the image forming apparatus need only include one image forming unit. The image forming apparatus may adopt the rotary system. The chargers may each be a charger (e.g., a scorotron charger, a charging brush, or a corotron charger) other than the charging roller. The image forming apparatus may adopt the one-component development process using a one-component developer. The image forming apparatus may adopt a development system (e.g., a development system in which a magnetic roller also serves as a development roller without providing a development roller) other than the touchdown development system.

The image forming apparatus may adopt the direct transfer process. When the image forming apparatus adopts the direct transfer process, the toner images are directly transferred to a recording medium from the image bearing members with the image bearing members in contact with the recording medium. The image forming apparatus may not include a cleaner. The image forming apparatus may not include a static eliminator. The image forming apparatus of the present embodiment has been described so far.

### Third Embodiment: Process Cartridge

A third embodiment of the present disclosure relates to a process cartridge. The process cartridge of the present embodiment includes the photosensitive member of the first embodiment.

The process cartridge of the present embodiment is described with further reference to FIG. 2. The process cartridge of the present embodiment corresponds to each of the first image forming unit 62Y to the fourth image forming unit 62K. The process cartridge includes an image bearing member 65. Here, the image bearing member 65 is the photosensitive member (specifically, the photosensitive member 1) of the first embodiment. As described in the first embodiment, the photosensitive member of the first embodiment can have reduced environmental dependence of sensitivity and can inhibit occurrence of fogging in high-temperature and high-humidity environments. Therefore, the process cartridge of the present embodiment can have reduced environmental dependence of sensitivity and can inhibit occurrence of fogging in high-temperature and high-humidity environments.

The process cartridge may further include at least one (e.g., at least 1 and no greater than 7) selected from the group consisting of a charger 63, a light exposure device 61, a development device 64, a transfer device 70 (particularly, a primary transfer roller 71), a cleaning member 661, a rubbing roller 662, and a static eliminator 67 in addition to the image bearing member 65. The process cartridge is designed to be freely attachable to and detachable from the image forming apparatus 100. In the above configuration, the process cartridge is easy to handle and can be replaced, when sensitivity characteristics or the like of an image bearing member 65 degrade, with another process cartridge including an image bearing member 65. The process cartridge of the present embodiment has been described with further reference to FIG. 2.

### [Substituents]

The following describes the substituents used in the present specification. Examples of the halogen atom (halogen group) include a fluorine atom (fluoro group), a chlorine atom (chloro group), a bromine atom (bromo group), and an iodine atom (iodo group).

The alkyl groups each are an unsubstituted straight chain or branched chain alkyl group unless otherwise stated. Examples of the alkyl group with a carbon number of at least 1 and no greater than 8 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, a straight chain or branched chain heptyl group, and a straight chain or branched chain octyl group. Examples of the other alkyl groups with different carbon numbers include those with corresponding carbon numbers among the above alkyl groups.

The alkoxy groups each are an unsubstituted straight chain or branched chain alkoxy group unless otherwise stated. Examples of the alkoxy group with a carbon number of at least 1 and no greater than 6 include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-etylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group. Examples of the other alkoxy groups with different carbon numbers include those with corresponding carbon numbers among the above alkoxy groups.

The aryl groups each are an unsubstituted aryl group unless otherwise stated. Examples of the aryl group with a carbon number of at least 6 and no greater than 14 include a phenyl group, a naphthyl group, an indacenyl group, a biphenylenyl group, an acenaphthylenyl group, an anthryl group, and a phenanthryl group. Examples of the other aryl groups with different carbon numbers include those with corresponding carbon numbers among the above aryl groups.

The alkenyl group is an unsubstituted straight chain or branched chain alkenyl group unless otherwise stated. The alkenyl group with a carbon number of at least 2 and no greater than 6 has at least 1 and no greater than 3 double bonds. Examples of the alkenyl group with a carbon number of at least 2 and no greater than 6 include an ethenyl group, a propenyl group, a butenyl group, a butadienyl group, a pentenyl group, a hexenyl group, a hexadienyl group, and a hexatrinyl group. The substituents used in the present specification have been described so far.

### EXAMPLES

The following describes the present disclosure further in detail using examples. However, the present disclosure is not limited to the scope of the examples.

### [Inorganic Particles]

Inorganic particles (T1) to (T7) shown below in Table 4 were prepared. The inorganic particles (T1) to the inorganic particles (T7) each were the specific inorganic particles. Note that the column titled “Surface treatment layers” in Table 4 indicates component(s) contained in the surface treatment layers of corresponding inorganic particles. For example, “Silica+Alumina” in the column titled “Surface treatment layers” for the inorganic particles (T1) means that the surface treatment layers contain silica and alumina. “MHPS” refers to methylhydrogenpolysiloxane. “Diameter” refers to number average primary particle diameter.

TABLE 4

| | | | | | Diameter |
|---|---|---|---|---|---|
| | Manufacturer | Tradename | Metal oxide particles | Surface treatment layers | [nm] |
| T1 | TAYCA CORPORATION | MT-05 | Titanium oxide particles | Silica + Alumina | 10 |
| T2 | ISHIHARA SANGYO KAISHA, LTD. | TTO-55(A) | Titanium oxide particles | Alumina | 40 |
| T3 | TAYCA CORPORATION | MT-100HD | Titanium oxide particles | Alumina + Zirconia | 30 |
| T4 | TAYCA CORPORATION | MZY-303S | zinc oxide particles | Silicone oil | 35 |
| T5 | TAYCA CORPORATION | MTY-700BS | Titanium oxide particles | Silicone oil | 80 |
| T6 | TAYCA CORPORATION | MTY-500SAS | Titanium oxide particles | Alumina + Silica + MHPS | 35 |
| T7 | TAYCA CORPORATION | MT-100Z | Titanium oxide particles | Alumina + Stearic acid | 15 |

### [Polyamide Resins]

Polyamide resins (A1) to (A6) formed with the monomers shown below in Table 5 were prepared as described below. Note that the polyamide resins (A1) to (A4) each were the specific polyamide resin among the polyamide resins (A1) to (A6).

### (Polyamide Resin (A1))

A four-necked flask equipped with a stirrer, a thermometer, a nitrogen inlet tube and a dewatering conduit was used as a reaction vessel. Into the reaction vessel, dodecanedioic acid (0.5 parts by mole) as a dicarboxylic acid and isophoronediamine (0.5 parts by mole) as a diamine were charged. Next, the inside of the reaction vessel was purged with nitrogen while stirring the contents of the reaction vessel. Thereafter, the above state was maintained until the end of the reaction. Next, the temperature of the contents of the reaction vessel was heated to 230° C. and the contents of the reaction vessel were allowed to react (dehydration condensation) for 4 hours at that temperature. After the end of the reaction, the internal pressure of the reaction vessel was reduced and the temperature thereof is kept at 250° C. for 2 hours in order to dehydrate water produced by the reaction. Thereafter, the inside of the reaction vessel was returned to the normal temperature and the normal pressure. Thus, the polyamide resin (A1) was obtained.

### (Polyamide Resins (A2) to (A5))

The polyamide resins (A2) to (A5) were prepared according to the same method as that for preparing the polyamide resin (A1) in all aspects other than that the monomers used were changed to those shown below in Table 5. Note that “MM” below in Table 5 refers to 4,4-methylenebis-2-methylcyclohexylamine.

### (Polyamide Resin (A6))

“AMILAN (registered Japanese trademark) CM8000” produced by Toray Industries, Inc. was prepared as the polyamide resin (A6). The polyamide resin (A6) was a copolymer of nylon 6, nylon 12, nylon 66, and nylon 610. The polyamide resin (A6) had a total percentage content of the first repeating unit derived from an aliphatic dicarboxylic acid and the second repeating unit derived from a diamine compound of less than 80% by mol.

TABLE 5

| | Dicarboxylic acid | | | Diamine | | Other | |
|---|---|---|---|---|---|---|---|
| | Type | Carbon number | % by mol | Type | % by mol | Type | % by mol |
| A1 | Dodecanedioic acid | 12 | 50 | Isophorondiamin | 50 | — | — |
| A2 | Decanedioic acid | 10 | 50 | Isophorondiamin | 50 | — | — |
| A3 | Octanedioic acid | 8 | 50 | Isophorondiamin | 50 | — | — |
| A4 | Dodecanedioic acid | 12 | 50 | MM | 50 | — | — |
| A5 | Hexanedioic acid | 6 | 35 | Diaminohexane | 35 | Caprolactam | 30 |

| | |
|---|---|
| A6 | Nylon copolymer |

### <Photosensitive Member Production>

Photosensitive members of Examples 1 to 42 and Comparative Examples 1 to 4, each of which were a positively chargeable single-layer photosensitive member, were produced by the following methods.

### Example 1

### (Intermediate Layer Formation)

First, 3 parts by mass of the inorganic particle (T1), 1 part by mass of the polyamide resin (A1), 12 parts by mass of ethanol, 4 parts by mass of n-butanol, and 4 parts by mass of toluene were mixed. The resulting mixture was stirred for 10 hours using a bead mill to sufficiently disperse the inorganic particles (T1) in a solvent (mixed organic solvent of ethanol, n-butanol, and toluene). Through the above, an application liquid for intermediate layer formation was prepared.

An aluminum drum-shaped support (diameter 30 mm, length 252.6 mm) was used as a conductive substrate. The aforementioned application liquid for intermediate layer formation was applied onto the conductive substrate by dip coating. Next, the conductive substrate after the application was dried at 130° C. for 30 minutes. Through the above, an intermediate layer (film thickness: 3 μm) was formed on the conductive substrate.

### (Single-Layer Photosensitive Layer Formation)

A mixed liquid was obtained by mixing 4.0 parts by mass of Y-form titanyl phthalocyanine, 3.0 parts by mass of the n-type pigment (Az1), 70.0 parts by mass of the hole transport material (HTM-1), 45.0 parts by mass of the electron transport material (ETM-1), 100.0 parts by mass of bisphenol Z polycarbonate resin (“PANLITE (registered Japanese trademark) TS2050”, product of TEIJIN LIMITED, viscosity average molecular weight: 50,000) as the binder resin, 0.1 parts by mass of a silicone oil (“KF96-50cs”, product of Shin-Etsu Chemical Co., Ltd., dimethyl silicone oil), and 760.0 parts by mass of tetrahydrofuran. Ultrasonic dispersion treatment was performed on the resulting mixed liquid for 20 minutes using a rod-shaped sonic oscillator to obtain an application liquid for photosensitive layer formation. Next, the application liquid for photosensitive layer formation was applied onto the intermediate layer on the conductive substrate by ring coating. The applied application liquid for photosensitive layer formation was dried at 130° C. for 30 minutes to form a single-layer photosensitive layer (film thickness: 30 μm) on the intermediate layer. Through the above, the photosensitive member of Example 1 was obtained.

### Examples 2 to 42 and Comparative Examples 1 to 4

Photosensitive members of Examples 2 to 42 and Comparative Examples 1 to 4 were produced according to the same method as that for producing the photosensitive member of Example 1 in all aspects other than the following changes. In the production of the photosensitive members of Examples 2 to 42 and Comparative Examples 1 to 4, the type and amount of the inorganic particles added to the application liquid for intermediate layer formation and the type of the polyamide resin were changed to those shown below in Tables 6 and 7. In addition, in the production of the photosensitive members of Examples 2 to 42 and Comparative Examples 1 to 4, the type and amount of the n-type pigment added to the application liquid for photosensitive layer formation and the types of the hole transport material and the electron transport material were changed to those shown below in Tables 6 and 7.

The terms in Tables 6 and 7 are as follows.
CGM: charge generating material
CGM-1: Y-form titanyl phthalocyanine
HTM: hole transport material
ETM: electron transport material
Resin 1: bisphenol Z polycarbonate resin (“PANLITE (registered Japanese trademark) TS2050”, product of TEIJIN LIMITED, viscosity average molecular weight: 50,000)

In Tables 6 and 7 below, “Part” in the column titled “Inorganic particles” means the content [parts by mass] of the inorganic particles relative to 100 parts by mass of the corresponding polyamide resin. “Part” in the column titled “n-type pigment” means the content [parts by mass] of the n-type pigment relative to 100 parts by mass of the binder resin in the corresponding photosensitive layer.

TABLE 6

| | Intermediate layer | | | Photosensitive layer | | | | | |
|---|---|---|---|---|---|---|---|---|---|
| | Inorganic particles | | | | n-type pigment | | | | |
| | Type | Part | Polyamide resin | CGM | Type | Part | HTM | ETM | Binder resin |
| Example 1 | T1 | 3 | A1 | CGM-1 | Az1 | 3.0 | HTM-1 | ETM-1 | Resin 1 |
| Example 2 | T1 | 3 | A2 | CGM-1 | Az1 | 3.0 | HTM-1 | ETM-1 | Resin 1 |
| Example 3 | T1 | 3 | A3 | CGM-1 | Az1 | 3.0 | HTM-1 | ETM-1 | Resin 1 |
| Example 4 | T1 | 3 | A4 | CGM-1 | Az1 | 3.0 | HTM-1 | ETM-1 | Resin 1 |
| Example 5 | T2 | 3 | A1 | CGM-1 | Az1 | 3.0 | HTM-1 | ETM-1 | Resin 1 |
| Example 6 | T3 | 3 | A1 | CGM-1 | Az1 | 3.0 | HTM-1 | ETM-1 | Resin 1 |
| Example 7 | T4 | 3 | A1 | CGM-1 | Az1 | 3.0 | HTM-1 | ETM-1 | Resin 1 |
| Example 8 | T5 | 3 | A1 | CGM-1 | Az1 | 3.0 | HTM-1 | ETM-1 | Resin 1 |
| Example 9 | T6 | 3 | A1 | CGM-1 | Az1 | 3.0 | HTM-1 | ETM-1 | Resin 1 |
| Example 10 | T7 | 3 | A1 | CGM-1 | Az1 | 3.0 | HTM-1 | ETM-1 | Resin 1 |
| Example 11 | T1 | 3 | A1 | CGM-1 | Az2 | 3.0 | HTM-1 | ETM-1 | Resin 1 |
| Example 12 | T1 | 3 | A1 | CGM-1 | Az3 | 3.0 | HTM-1 | ETM-1 | Resin 1 |
| Example 13 | T1 | 3 | A1 | CGM-1 | Az4 | 3.0 | HTM-1 | ETM-1 | Resin 1 |
| Example 14 | T1 | 3 | A1 | CGM-1 | Az5 | 3.0 | HTM-1 | ETM-1 | Resin 1 |
| Example 15 | T1 | 3 | A1 | CGM-1 | P1 | 3.0 | HTM-1 | ETM-1 | Resin 1 |
| Example 16 | T1 | 3 | A1 | CGM-1 | P2 | 3.0 | HTM-1 | ETM-1 | Resin 1 |
| Example 17 | T1 | 3 | A1 | CGM-1 | P3 | 3.0 | HTM-1 | ETM-1 | Resin 1 |
| Example 18 | T1 | 3 | A1 | CGM-1 | P4 | 3.0 | HTM-1 | ETM-1 | Resin 1 |
| Example 19 | T1 | 3 | A1 | CGM-1 | I1 | 3.0 | HTM-1 | ETM-1 | Resin 1 |
| Example 20 | T1 | 3 | A1 | CGM-1 | I2 | 3.0 | HTM-1 | ETM-1 | Resin 1 |
| Example 21 | T1 | 3 | A1 | CGM-1 | Az1 | 3.0 | HTM-2 | ETM-1 | Resin 1 |
| Example 22 | T1 | 3 | A1 | CGM-1 | Az1 | 3.0 | HTM-3 | ETM-1 | Resin 1 |
| Example 23 | T1 | 3 | A1 | CGM-1 | Az1 | 3.0 | HTM-4 | ETM-1 | Resin 1 |
| Example 24 | T1 | 3 | A1 | CGM-1 | Az1 | 3.0 | HTM-5 | ETM-1 | Resin 1 |
| Example 25 | T1 | 3 | A1 | CGM-1 | Az1 | 3.0 | HTM-6 | ETM-1 | Resin 1 |

TABLE 7

| | Intermediate layer | | | Photosensitive layer | | | | | |
|---|---|---|---|---|---|---|---|---|---|
| | Inorganic particles | | Polyamide | | n-type pigment | | | | |
| | Type | Part | resin | CGM | Type | Part | HTM | ETM | Binder resin |
| Example 26 | T1 | 3 | A1 | CGM-1 | Az1 | 3.0 | HTM-7 | ETM-1 | Resin 1 |
| Example 27 | T1 | 3 | A1 | CGM-1 | Az1 | 3.0 | HTM-8 | ETM-1 | Resin 1 |
| Example 28 | T1 | 3 | A1 | CGM-1 | Az1 | 3.0 | HTM-9 | ETM-1 | Resin 1 |
| Example 29 | T1 | 3 | A1 | CGM-1 | Az1 | 3.0 | HTM-10 | ETM-1 | Resin 1 |
| Example 30 | T1 | 3 | A1 | CGM-1 | Az1 | 3.0 | HTM-11 | ETM-1 | Resin 1 |
| Example 31 | T1 | 3 | A1 | CGM-1 | Az1 | 3.0 | HTM-12 | ETM-1 | Resin 1 |
| Example 32 | T1 | 3 | A1 | CGM-1 | Az1 | 3.0 | HTM-1 | ETM-2 | Resin 1 |
| Example 33 | T1 | 3 | A1 | CGM-1 | Az1 | 3.0 | HTM-1 | ETM-3 | Resin 1 |
| Example 34 | T1 | 3 | A1 | CGM-1 | Az1 | 3.0 | HTM-1 | ETM-4 | Resin 1 |
| Example 35 | T1 | 3 | A1 | CGM-1 | Az1 | 3.0 | HTM-1 | ETM-5 | Resin 1 |
| Example 36 | T1 | 3 | A1 | CGM-1 | Az1 | 3.0 | HTM-1 | ETM-6 | Resin 1 |
| Example 37 | T1 | 3 | A1 | CGM-1 | Az1 | 3.0 | HTM-1 | ETM-7 | Resin 1 |
| Example 38 | T1 | 3 | A1 | CGM-1 | Az1 | 3.0 | HTM-1 | ETM-8 | Resin 1 |
| Example 39 | T1 | 1 | A1 | CGM-1 | Az1 | 3.0 | HTM-1 | ETM-1 | Resin 1 |
| Example 40 | T1 | 6 | A1 | CGM-1 | Az1 | 3.0 | HTM-1 | ETM-1 | Resin 1 |
| Example 41 | T1 | 3 | A1 | CGM-1 | Az1 | 1.0 | HTM-1 | ETM-1 | Resin 1 |
| Example 42 | T1 | 3 | A1 | CGM-1 | Az1 | 15.0 | HTM-1 | ETM-1 | Resin 1 |
| Comparative Example 1 | T1 | 3 | A5 | CGM-1 | Az1 | 3.0 | HTM-1 | ETM-1 | Resin 1 |
| Comparative Example 2 | T1 | 3 | A6 | CGM-1 | Az1 | 3.0 | HTM-1 | ETM-1 | Resin 1 |
| Comparative Example 3 | T1 | 3 | A1 | CGM-1 | — | — | HTM-1 | ETM-1 | Resin 1 |
| Comparative Example 4 | — | — | A1 | CGM-1 | Az1 | 3.0 | HTM-1 | ETM-1 | Resin 1 |

### <Single-Layer Photosensitive Member Evaluation>

Environmental dependence of sensitivity and fogging in high-temperature and high-humidity environments were evaluated for each of the photosensitive members of Examples 1 to 42 and Comparative Examples 1 to 4 by the following methods. Evaluation results and confirmation results were shown below in Table 8.

### [Environmental Dependence of Sensitivity]

The sensitivity of the photosensitive member being a measurement target was measured in an environment (LL environment) at a temperature of 10° C. and a humidity of 15% RH using a drum sensitivity test device (product of GENTEC CO., LTD.). In detail, the photosensitive member was charged to have a surface potential of +800 V using the drum sensitivity test device. Next, the surface of the photosensitive member was irradiated with monochrome light (wavelength: 780 nm, optical energy: 0.5 μJ/cm²) taken out of light of a halogen lamp using a bandpass filter. The surface potential of the photosensitive member was measured at a time point when 50 milliseconds elapsed after the monochromatic light irradiation. The measured surface potential was used as a post-exposure potential V_{L} (LL) (unit: +V) in the LL environment. Next, the same measurement was performed as the measurement of the post-exposure potential V_{L} (LL) in the LL environment in all aspects other than that the environment for measurement was changed to an environment (HH environment) at a temperature of 30° C. and a humidity of 80% RH. The measured surface potential was used as a post-exposure potential V_{L}(HH) (unit: +V) in the HH environment. By applying V_{L} (LL) and V_{L} (HH) to the following equation, ΔV_{L} was calculated. The lower the environmental dependence of sensitivity of a photosensitive member, the smaller the value of ΔV_{L}. Environmental dependence of sensitivity of the photosensitive member was evaluated according to the following criteria.

$$Δ {V}_{L} = {V}_{L} ( LL ) - {V}_{L} ( HH )$$

### (Criteria of Environmental Dependence of Sensitivity)

A (good): ΔV_{L} of no greater than 40 (unit: +V)
B (poor): ΔV_{L} of greater than 40 (unit: +V)

### [Fogging in High-Temperature and High-Humidity Environments]

A printer (“ECOSYS (registered Japanese trademark) P2040dw” produced by KYOCERA Document Solutions Japan Inc.) was used as an evaluation apparatus. The photosensitive member of the evaluation apparatus was removed from the evaluation apparatus and the photosensitive member being an evaluation target was mounted in the evaluation apparatus. The developer standardly supplied with the aforementioned printers was used as an evaluation developer. In an environment (HH environment) at a temperature of 30° C. and a humidity of 80% RH, a gray image was formed on a sheet of printing paper using the evaluation apparatus. The sheet of the printing paper with the gray image formed thereon was visually observed to check for the presence or absence of image defects identified as fog. Fogging in high-temperature and high-humidity environments was evaluated according to the following criteria.

### (Criteria of Fogging in High-Temperature and High-Humidity Environments)

A (good): No fog was observed in sheet of printing paper.
B (poor): Fog was observed in sheet of printing paper.

TABLE 8

| | Environmental dependence | | |
|---|---|---|---|
| | of sensitivity | | Fogging |
| | ΔV_{L} [+V] | Rating | in HH |
| Example 1 | 23 | A | A |
| Example 2 | 22 | A | A |
| Example 3 | 26 | A | A |
| Example 4 | 24 | A | A |
| Example 5 | 26 | A | A |
| Example 6 | 25 | A | A |
| Example 7 | 24 | A | A |
| Example 8 | 26 | A | A |
| Example 9 | 31 | A | A |
| Example 10 | 36 | A | A |
| Example 11 | 26 | A | A |
| Example 12 | 26 | A | A |
| Example 13 | 25 | A | A |
| Example 14 | 25 | A | A |
| Example 15 | 30 | A | A |
| Example 16 | 29 | A | A |
| Example 17 | 30 | A | A |
| Example 18 | 31 | A | A |
| Example 19 | 24 | A | A |
| Example 20 | 23 | A | A |
| Example 21 | 25 | A | A |
| Example 22 | 24 | A | A |
| Example 23 | 25 | A | A |
| Example 24 | 27 | A | A |
| Example 25 | 27 | A | A |
| Example 26 | 28 | A | A |
| Example 27 | 26 | A | A |
| Example 28 | 26 | A | A |
| Example 29 | 25 | A | A |
| Example 30 | 25 | A | A |
| Example 31 | 28 | A | A |
| Example 32 | 25 | A | A |
| Example 33 | 26 | A | A |
| Example 34 | 25 | A | A |
| Example 35 | 27 | A | A |
| Example 36 | 25 | A | A |
| Example 37 | 25 | A | A |
| Example 38 | 28 | A | A |
| Example 39 | 32 | A | A |
| Example 40 | 19 | A | A |
| Example 41 | 25 | A | A |
| Example 42 | 32 | A | A |
| Comparative Example 1 | 49 | B | B |
| Comparative Example 2 | 61 | B | B |
| Comparative Example 3 | 43 | B | B |
| Comparative Example 4 | Unmeasurable | B | Unmeasurable |

As shown in Tables 6 to 8, the photosensitive members of Examples 1 to 42 each included a conductive substrate, an intermediate layer provided on the conductive substrate, and a photosensitive layer provided on the intermediate layer. The intermediate layer contained a specific polyamide resin and specific inorganic particles. The specific inorganic particles included metal oxide particles. The specific polyamide resin included a first repeating unit derived from an aliphatic dicarboxylic acid and a second repeating unit derived from a diamine compound. The total percentage content of the first repeating unit and the second repeating unit was at least 80% by mol to all repeating units included in the specific polyamide resin. The photosensitive layer contained a charge generating material, an electron transport material, a binder resin, a hole transport material, and an n-type pigment. The photosensitive members of Examples 1 to 42 had reduced environmental dependence of sensitivity and inhibited occurrence of fogging in the high-temperature and high-humidity environments.

In each of the photosensitive members of Comparative Examples 1 and 2 by contrast, a polyamide resin other than the specific polyamide resin was used as a polyamide resin in the intermediate layer. The photosensitive members of Comparative Examples 1 and 2 are determined to be highly hygroscopic due to the intermediate layer not containing the specific polyamide resin. As a result, the photosensitive members of Comparative Examples 1 and 2 were rated as poor in environmental dependence of sensitivity and fogging in high-temperature and high-humidity environments.

The photosensitive member of Comparative Example 3 included a photosensitive layer containing no n-type pigments. The photosensitive member of Comparative Example 3, which contained no n-type pigments in the photosensitive layer, had insufficient sensitivity (particularly, sensitivity in low-temperature and low-humidity environments). As a result, the photosensitive member of Comparative Example 3 was rated as poor in environmental dependence of sensitivity. The photosensitive member of Comparative Example 3 was also rated as poor in fogging in high-temperature and high-humidity environments.

The intermediate layer of the photosensitive member of Comparative Example 4 contained no specific inorganic particles. The photosensitive member of Comparative Example 4, which contained no specific inorganic particles in the intermediate layer, insufficiently exhibited the function of the intermediate layer. Here, the function of the intermediate layer is to inhibit an increase in resistance by allowing electric current generated during photosensitive member exposure to light to smoothly flow. As a result, the photosensitive member of Comparative Example 4 was rated as poor in environmental dependence of sensitivity and fogging in high-temperature and high-humidity environments (an image at a level suitable for evaluation was not formed).

What is claimed is:

1. An electrophotographic photosensitive member comprising:
a conductive substrate;
an intermediate layer provided on the conductive substrate; and
a photosensitive layer provided on the intermediate layer, wherein
the intermediate layer contains a specific polyamide resin and specific organic particles,
the specific inorganic particles include metal oxide particles,
the specific polyamide resin includes a first repeating unit derived from an aliphatic dicarboxylic acid and a second repeating unit derived from a diamine compound,
a total percentage content of the first repeating unit and the second repeating unit is at least 80% by mol to all repeating units included in the specific polyamide resin, and
the photosensitive layer contains a charge generating material, an electron transport material, a binder resin, a hole transport material, and an n-type pigment.

2. The electrophotographic photosensitive member according to claim 1, wherein
the charge generating material includes titanyl phthalocyanine having a Y-form crystal structure.

3. The electrophotographic photosensitive member according to claim 1, wherein
the metal oxide particles are titanium oxide particles.

4. The electrophotographic photosensitive member according to claim 1, wherein
the diamine compound has a cycloalkane structure.

5. The electrophotographic photosensitive member according to claim 1, wherein
the aliphatic dicarboxylic acid has a carbon number of at least 8 and no greater than 20.

6. The electrophotographic photosensitive member according to claim 1, wherein
the specific inorganic particles include surface treatment layers covering at least parts of surfaces of the metal oxide particles, and
the surface treatment layers contain at least one of aluminum oxide, silica, zirconia, stearic acid, and a component derived from an organic siloxane compound.

7. The electrophotographic photosensitive member according to claim 1, wherein
the n-type pigment includes at least one of an azo pigment, a perylene pigment, and an isoindoline pigment.

8. The electrophotographic photosensitive member according to claim 1, wherein
the n-type pigment includes at least one of compounds represented by formulas (Az1) to (Az5), (P1) to (P4), (I1), and (I2) below:

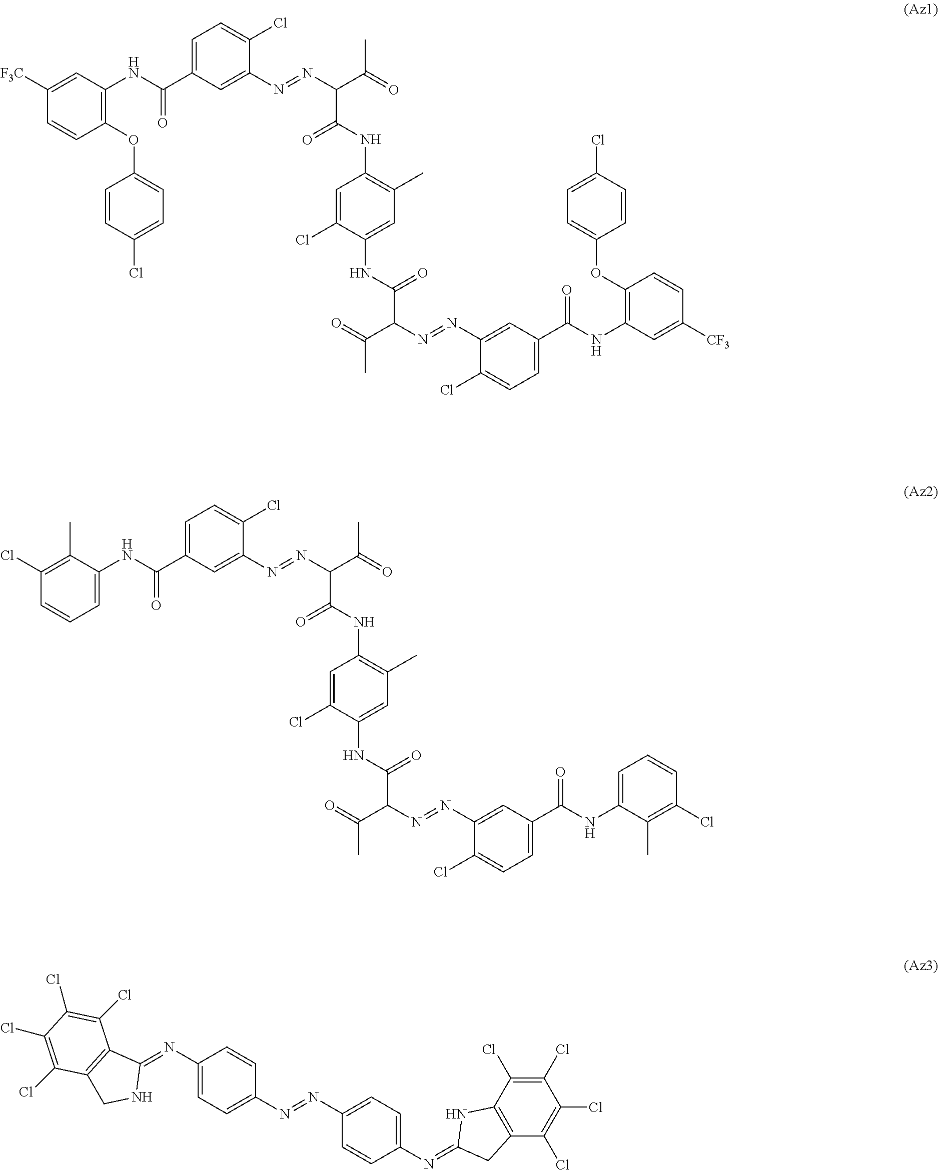 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C ; CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C ; Clc1c(Cl)c(Cl)c2c(c1Cl)C/C(=N/c1ccc(/N=N/c3ccc(/N=C4\NCc5c(Cl)c(Cl)c(Cl)c(Cl)c54)cc3)cc1)N2]

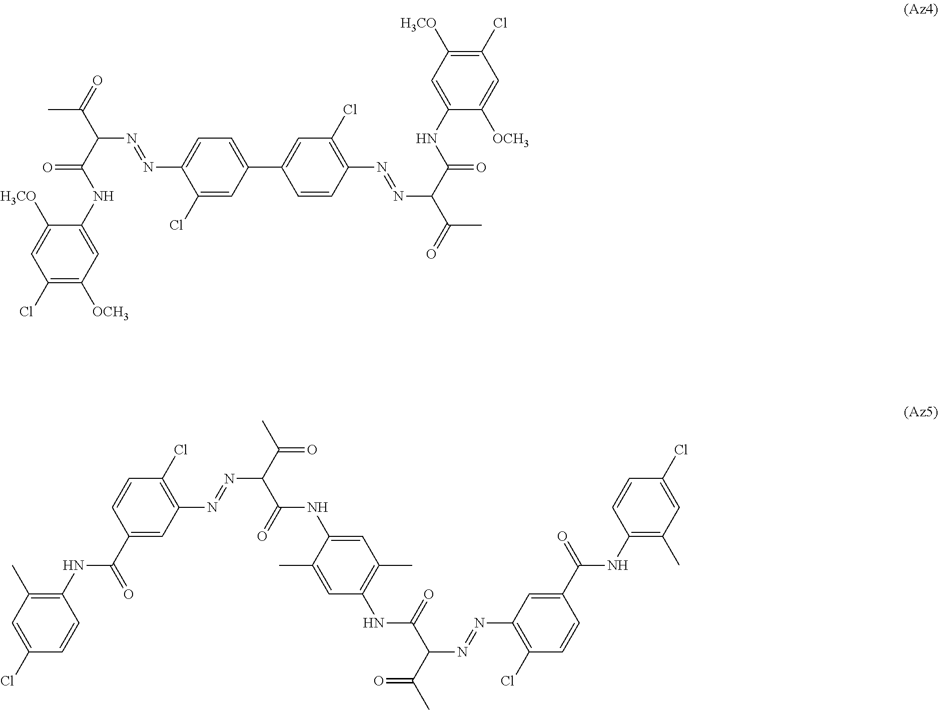 [SMILES: COc1cc(NC(=O)C(/N=N/c2ccc(-c3ccc(/N=N/C(C(C)=O)C(=O)Nc4cc(OC)c(Cl)cc4OC)c(Cl)c3)cc2Cl)C(C)=O)c(OC)cc1Cl ; CC(=O)C(/N=N/c1cc(C(=O)Nc2ccc(Cl)cc2C)ccc1Cl)C(=O)Nc1cc(C)c(NC(=O)C(/N=N/c2cc(C(=O)Nc3ccc(Cl)cc3C)ccc2Cl)C(C)=O)cc1C]

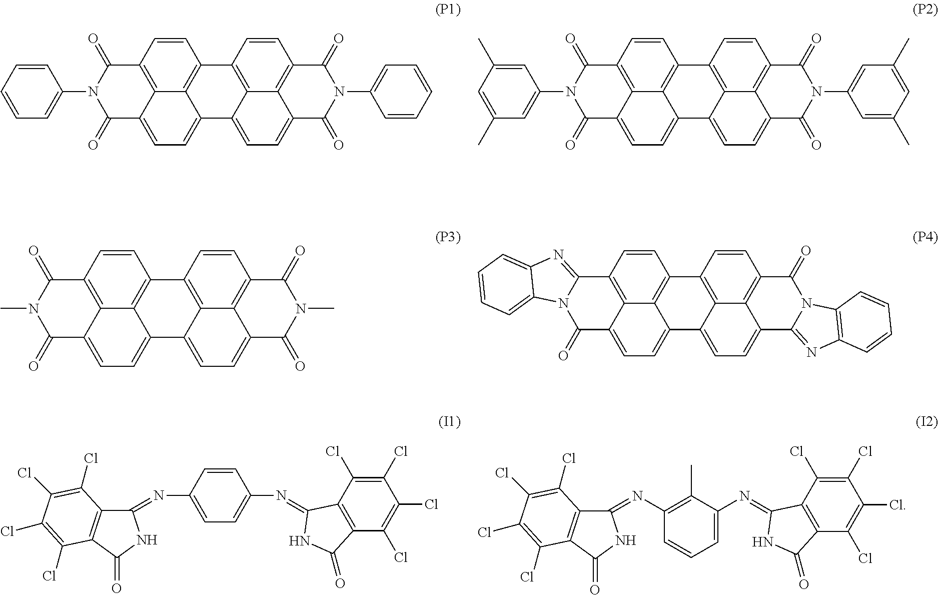

9. The electrophotographic photosensitive member according to claim 1, wherein
the electron transport material includes at least one of compounds represented by formulas (ETM-1) to (ETM-8) below:

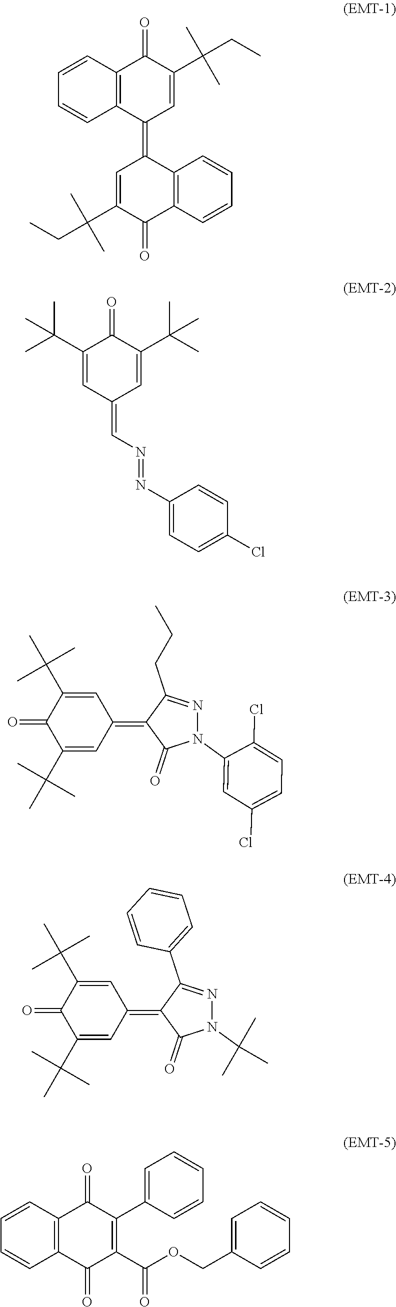

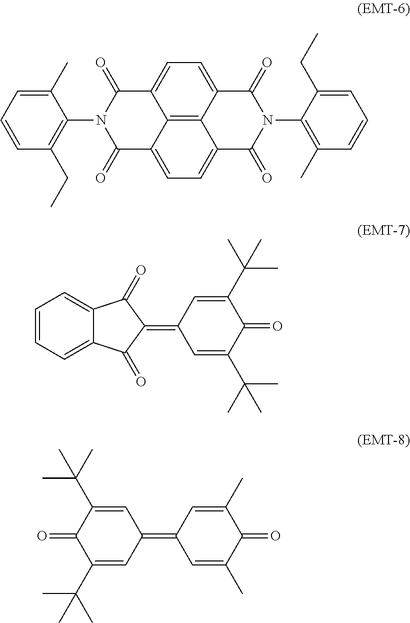

10. The electrophotographic photosensitive member according to claim 1, wherein
the hole transport material includes at least one of compounds represented by formulas (HTM-1) to (HTM-12) below:

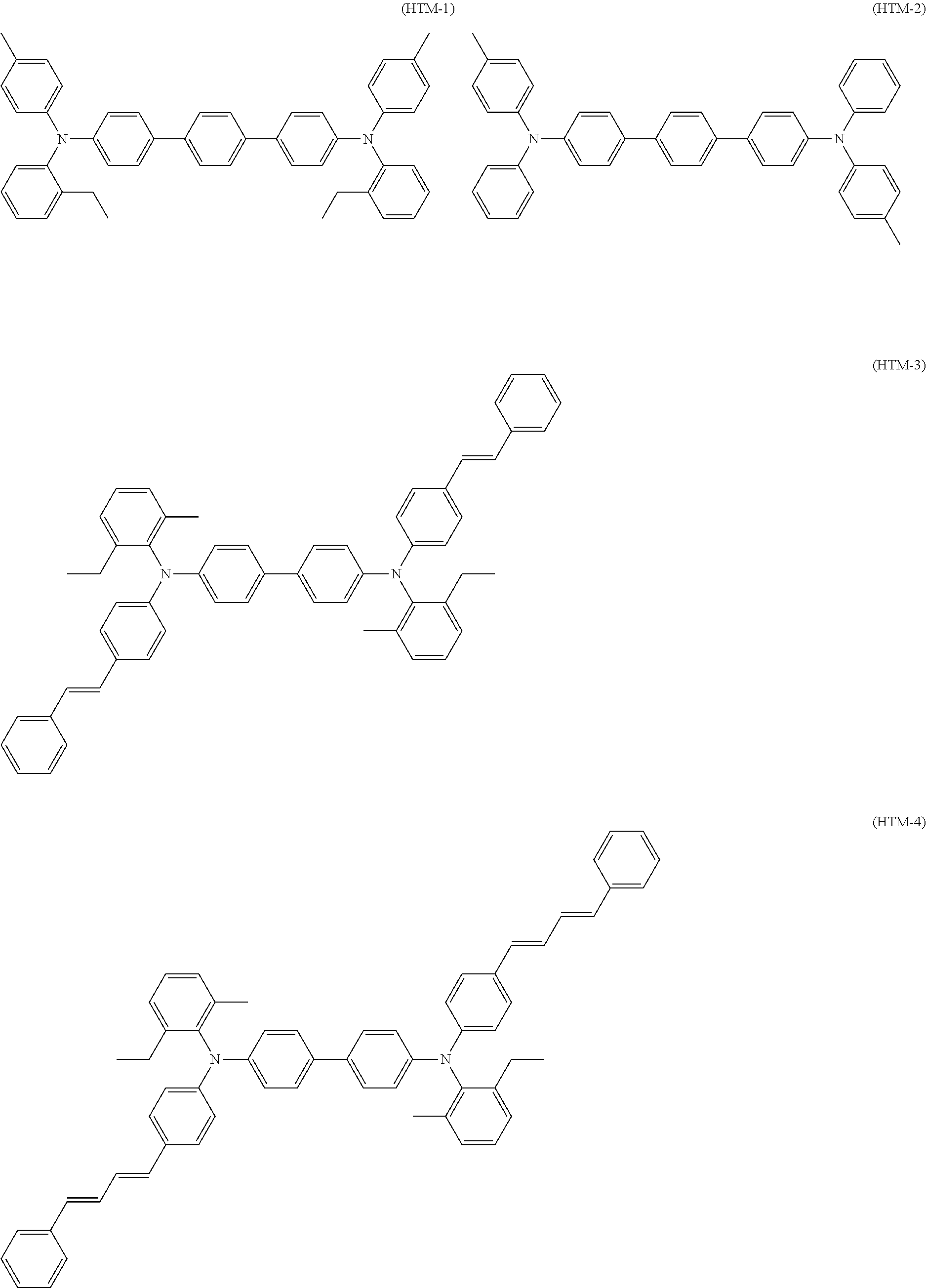

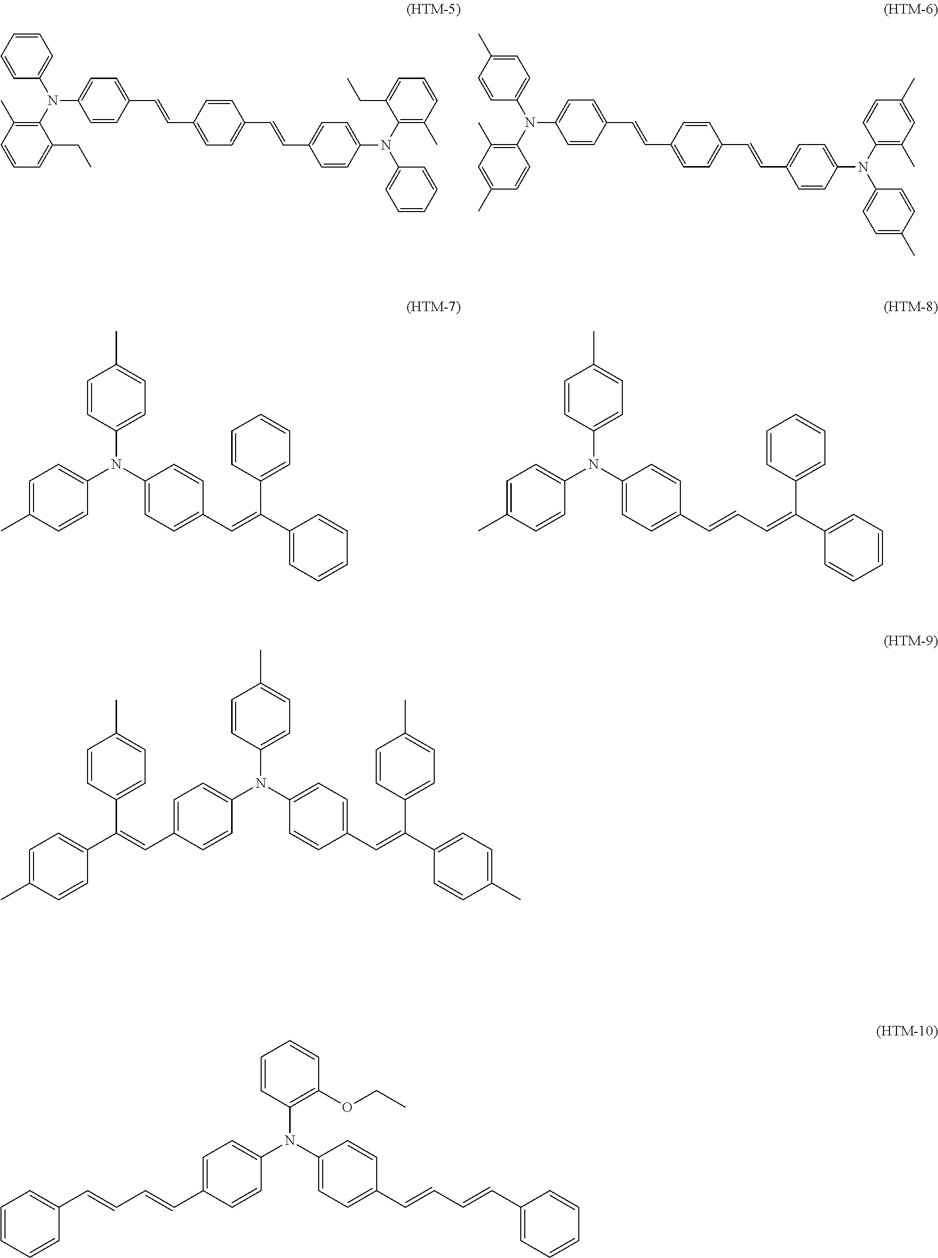

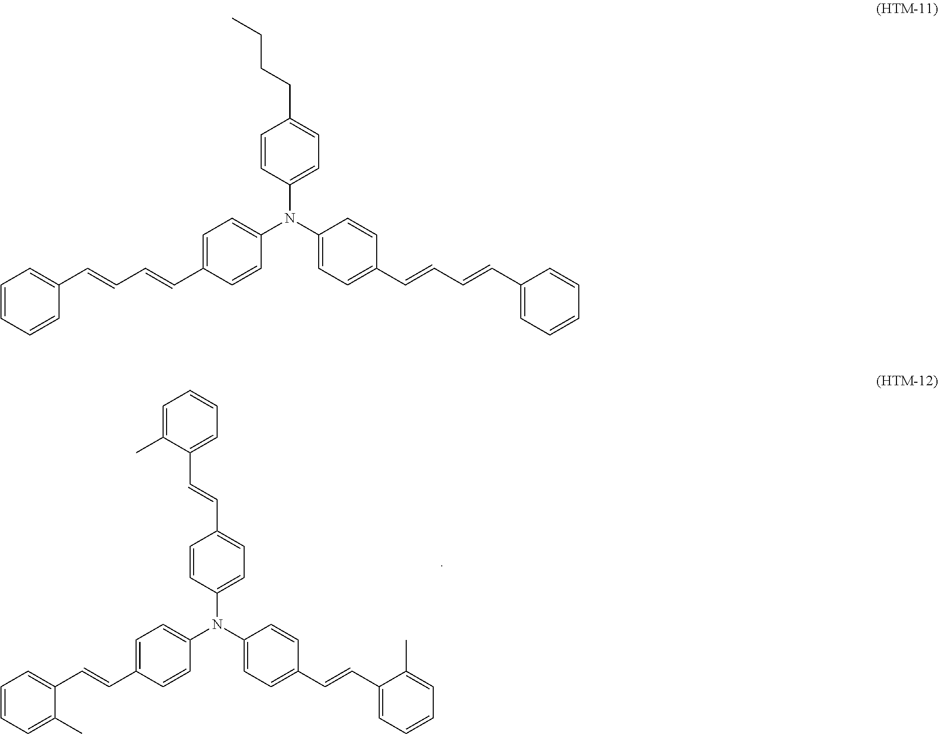 [SMILES: CCCCc1ccc(N(c2ccc(/C=C/C=C/c3ccccc3)cc2)c2ccc(/C=C/C=C/c3ccccc3)cc2)cc1 ; Cc1ccccc1/C=C/c1ccc(N(c2ccc(/C=C/c3ccccc3C)cc2)c2ccc(/C=C/c3ccccc3C)cc2)cc1]

11. The electrophotographic photosensitive member according to claim 1, wherein
the n-type pigment has a content of at least 0.5 parts by mass and no greater than 20.0 parts by mass relative to 100 parts by mass of the binder resin in the photosensitive layer.

12. The electrophotographic photosensitive member according to claim 1, wherein
the specific inorganic particles have a content of at least 50 parts by mass and no greater than 1000 parts by mass relative to 100 parts by mass of the specific polyamide resin in the intermediate layer.

13. The electrophotographic photosensitive member according to claim 1, wherein
the specific inorganic particles have a number average primary particle diameter of at least 5 nm and no greater than 100 nm.

14. A process cartridge comprising
the electrophotographic photosensitive member according to claim 1.

15. An image forming apparatus comprising:
an image bearing member;
a charger that changes a surface of the image bearing member;
a light exposure device that exposes the charged surface of the image bearing member to light to form an electrostatic latent image on the surface of the image bearing member;
a development device that develops the electrostatic latent image into a toner image by supplying toner to the surface of the image bearing member; and
a transfer device that transfers the toner image from the image bearing member to a transfer target, wherein
the image bearing member is the electrophotographic photosensitive member according to claim 1.
